(19) United States
(12) Patent Application Publication
(10) Pub. No.: US 2005/0020448 A1
(43) Pub. Date: Jan. 27, 2005

(54) Paper, image-recording material support, and image-recording material

(75) Inventors: Shigehisa Tamagawa, Shizuoka (JP); Fuyuhiko Mori, Shizuoka (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 10/893,886

(22) Filed: Jul. 20, 2004

(30) Foreign Application Priority Data
Jul. 23, 2003 (JP) 2003-200599
Aug. 1, 2003 (JP) 2003-205472
Aug. 1, 2003 (JP) 2003-205473

(51) Int. Cl. B41M 5/20

(52) U.S. Cl. 503/227

(57) ABSTRACT

Paper and an image-recording material support which have high surface planarity and excellent gloss are disclosed. Moreover, an image-recording material is disclosed which uses the image-recording material support and is capable of obtaining high quality image. The paper includes raw paper. The paper satisfies at least one of the following conditions (i) and (ii): (i) the paper has an inner bonding strength of 160 mJ or more specified in Japan Technical Association of the Pulp and Paper Industry No. 54, and an average center surface roughness (SRa) on at least one face of the paper is 0.9 μm or less at a cutoff wavelength of 0.3 mm to 0.4 mm, and (ii) an Oken type smoothness S (second) on the at least one face of the paper, and a density ρ (g/cm³) of the paper satisfy an expression S^{1/2}/ρ³≧15.

### BACKGROUND OF THE INVENTION

1. Field of the Invention

The present invention relates to paper having high surface planarity and excellent gloss. Moreover, the present invention relates to paper, an image-recording material support and an image-recording material which are preferably used for an electrophotographic material, a heat sensitive material, an inkjet-recording material, a sublimation transfer material, a silver salt photographic material, a heat transfer material, and the like.

2. Description of the Related Art

Conventionally, raw paper, synthetic paper, synthetic resin sheet, coat paper, laminate paper, and the like are well known as a support for various image-recording materials such as an electrophotographic material, a heat sensitive material, an inkjet-recording material, a sublimation transfer material, a silver salt photographic material, a heat transfer material, and the like. The above image-recording materials are used for image-recording so as to obtain an image print having high quality and high gloss. For this purpose, high planarity is needed for the above image-recording materials, which also involves necessity for high planarity of the support therefor.

For satisfying the above, various proposals have been made. Japanese Patent Application Publication (JP-B) No. 06-55545 discloses an image-recording material support formed with an intermediate layer (containing a white pigment) on raw paper (containing a polyolefin synthetic pulp) having a density of 0.8 g/cm³ to 1.0 g/cm³. Japanese Patent Application Laid-Open No. 11-11004 discloses an image-recording material support having its inner bonding strength in a range from 0.9 kg·cm to 2.2 kg·cm and having its friction coefficient in a range from 0.6 to 1.2. JP-A No. 2001-301098 discloses an image-recording material support having its average center surface roughness (SRa) of 0.75 μm or less measured at a cutoff wavelength of 5 mm to 7 mm. Moreover, JP-B No. 2671154 discloses an image-recording material support having pulp's average degree of polymerization of 800 or more and having an inner bonding strength (of raw paper) in a range from 1.0 kgf·cm to 2.0 kgf·cm, and having pH (of face of raw paper) of 6.0 or more.

When the image-recording material support has low strength, use of the image-recording material having the support for recording an image may cause a curl to an image print which is outputted from a printer. In addition, the image-recording material support having low planarity cannot form an image that has high-quality and high gloss. Moreover, raw materials of the above image-receiving material support are natural pulps such as needle-leaf tree (hereinafter, when necessary, referred to as “needle-leaf tree pulp”), broad-leaf (hereinafter, when necessary, referred to as “broad-leaf tree pulp”), and the like, which are to be produced by drying wet paper with a manual paper-making machine. The image-recording material support thus produced may result in deteriorated planarity which is attributable to shrink of pulp fiber of the natural pulρ (raw material) during the drying.

Any of the proposals disclosed in the above publications cannot solve the problems sufficiently. Such an image-recording material support is not proposed yet as having high planarity and extremely excellent gloss. In addition, such an image-recording material is not proposed yet as having a support therefor, having high-quality image and excellent gloss after image-recording, having high rigidity (stiffness), and causing a small curl. Developments of the above are desired.

Conventionally, paper that is efficiently machined at high speed is dried between many cylindrical driers by receiving a tension in the longitudinal direction (paper-making direction) while causing free shrinkage in the lateral direction. When being subjected to a change in humidity, the thus machined paper is likely to cause a large extension and/or shrinkage (telescopic motion) in the lateral direction. With this, recordings such as photographing with the above paper as a support may increase curl in size, thus high-quality image cannot be formed.

To solve the above problem, JP-A No. 01-292354 (equivalent of JP-B No. 2739160) discloses an electrophotographic transfer paper having a small shrinkage factor, an excellent surface smoothness, and causing a small curl, even when the paper is subjected to a humidity change after drying. Specifically, the above electrophotographic transfer paper is machined with so-called a Yankee paper machine that can control drying shrinkage both in the longitudinal and lateral directions, without receiving a longitudinal tension during drying.

In this case, however, using the Yankee paper machine may generally restrict many paper-making conditions such as freeness of pulp paper material, paper-making speed, and the like.

On the other hand, a treatment in which a sheet of paper is dried while being pressurized (hereinafter may be referred to as press dry treatment) is expected to provide higher strength, elasticity modulus, density and the like, and such process is currently under development (Takuya Kadoya et al., Seishi Kagaku “Science of paper-making” (Tokyo: Chugai Sangyo Chosakai, 1982), pp. 174-177), Jun. 30, 1982 (Showa 57). In addition, JP-A No. 2000-500536 and JP-A No. 07-91829 (JP-B No. 3041754) propose web pressure drying apparatuses which perform heat drying of a fiber web with a press dry treatment and provide less restrictions when used in a manufacturing line. In the above conventional technologies, however, no specific press drying conditions and the like are disclosed. JP-A No. 2000-500536 and JP-A No. 07-91829 UP-B No. 3041754) only disclose the press drying apparatuses, with no descriptions about relation between the press drying treatment and image-recording material support.

On the other hand, conventionally, raw paper, synthetic paper, a synthetic resin sheet, coat paper, laminate paper, and the like are well known for use as an image-recording material support. Among these, the coat paper and the laminate paper are preferable.

Methods of producing the coat paper and the laminate paper comprise a solvent coating method of applying to raw paper a thermoplastic resin which is solved in an organic solvent, an aqueous coating method of applying to raw paper a thermoplastic resin which is made into a latex or an aqueous solution (varnish), a dry laminate method of a thermoplastic resin, a melting extrusion coating method, and the like.

However, the above solvent coating method that uses a harmful organic solvent may cause harmful effect on the environment. In the above aqueous coating method, water may swell the raw paper when the latex or the aqueous solution (varnish) is applied to the raw paper, thus losing smoothness of the raw paper, which is so called a “return.” Moreover, the aqueous coating method is not applicable to resins which are less likely to be made into latex or aqueous solution.

Summarizing the above, such an image-recording material support and an image-recording material are not proposed as having high surface smoothness and extremely excellent gloss, leaving an issue of further improvement and development.

It is therefore an object of the present invention to provide paper and an image-recording material support which have high planarity and excellent gloss. It is another object of the present invention to provide an image-recording material which has high-quality image and high gloss after image-forming, and causes a small curl.

### SUMMARY OF THE INVENTION

Under the present invention, a paper according to its first aspect comprises a raw paper. The paper satisfies the following: the paper has an inner bonding strength of 160 mJ or more specified in Japan Technical Association of the Pulp and Paper Industry No. 54, and an average center surface roughness on at least one face of the paper is 0.9 μm or less at a cutoff wavelength of 0.3 mm to 0.4 mm.

As a result, the paper according to its first aspect having the inner bonding strength and the average center surface roughness (SRa) respectively in the above certain ranges can have high surface planarity and can be used preferably for an image-recording material support.

Under the present invention, a paper according to its second aspect comprises a raw paper. The paper satisfies the following: an Oken type smoothness S (second) on the at least one face of the paper, and a density ρ (g/cm³) of the paper satisfy an expression S^{1/2}/ρ³≧15.

As a result, the paper according to its second aspect satisfying that the Oken type smoothness S and the density of the paper satisfy the first expression can have high surface planarity and an extremely excellent gloss and can be used preferably for the image-recording material support.

Under the present invention, an image-recording material support according to its first aspect comprises a paper which comprises a raw paper. The paper satisfies at least one of the following conditions (i) and (ii): (i) the paper has an inner bonding strength of 160 mJ or more specified in Japan Technical Association of the Pulp and Paper Industry No. 54, and an average center surface roughness on at least one face of the paper is 0.9 μm or less at a cutoff wavelength of 0.3 mm to 0.4 mm, and (ii) an Oken type smoothness S (second) on the at least one face of the paper, and a density ρ (g/cm³) of the paper satisfy an expression S^{1/2}/ρ³≧15.

As a result, the image-recording material support according to its first aspect can have high surface planarity and an extremely excellent gloss and can be used preferably for the image-recording material.

Under the present invention, an image-recording material support according to its second aspect comprises a raw paper subjected to a press dry treatment; and a coat layer. The coat layer is made by subjecting a face of the raw paper to a surface treatment using a member with a smooth surface, the face of the raw paper being to be formed with an image-recording layer.

With the press dry treatment, density, elasticity modulus, tensile strength, strength and the like can be improved. Moreover, a base paper which was subjected to the press dry treatment is formed with the coat layer, and the coat layer is allowed to abut on the smooth surface, for transferring the surface appearance.

As a result, the image-recording material support according to its second aspect can have high surface planarity and an extremely excellent gloss.

An image-recording material under the present invention comprises a support; and an image-recording layer disposed on the support. The image-recording material uses, as the support, the image-recording material support according to at least one of its first aspect and its second aspect described above.

As a result, high-quality image can be provided for the image-recording materials for any of the applications including an electrophotographic material (electrophotographic image-receiving material), a heat sensitive material (heat sensitive coloring recording material), an inkjet-recording material, a sublimation transfer material (sublimation transfer image-receiving material), a silver salt photographic material (silver halide photographic photosensitive material), and a heat transfer material (heat transfer image-receiving material).

Further objects, features and advantages of the present invention will become apparent from the following description of the preferred embodiments with reference to the attached drawings.

### BRIEF DESCRIPTION OF THE DRAWINGS

FIG. 1 shows a schematic of an example of a press dry treatment apparatus under the present invention.

FIG. 2 shows a schematic of an example of a press dry treatment apparatus used for a production line under the present invention.

FIG. 3 shows a schematic of an example of a wet cast method under the present invention.

FIG. 4 shows an example of a gelatinization cast method under the present invention.

FIG. 5 shows an example of a rewet cast method under the present invention.

FIG. 6 shows a schematic of a fixing belt apparatus of a printer used for examples under the present invention.

### DESCRIPTION OF THE PREFERRED EMBODIMENTS

(Paper)

Under the present invention, a paper according to its first aspect comprises a raw paper. The paper has an inner bonding strength of 160 mJ or more specified in Japan Technical Association of the Pulp and Paper Industry (hereinafter referred to as “JAPAN TAPPI”) No. 54, and an average center surface roughness (SRa) on at least one face of the paper is 0.9 μm or less at a cutoff wavelength of 0.3 mm to 0.4 mm.

The inner bonding strength is the one that is specified in JAPAN TAPPI No. 54.

As long as being 160 mJ or more, the inner bonding strength is not particularly limited, and can be suitably selected according to the object. For example, the inner bonding strength is preferred to be 200 mJ or more, and more preferably 216 mJ or more.

The average center surface roughness (SRa) can be obtained by scanning three-dimensionally a plane having a certain roughness, and therefore is different from an average center line roughness (Ra) that can be obtained by scanning a linear roughness of a plane. As the roughness at the cutoff wavelength of 0.3 mm to 0.4 mm decreases, the surface may appear flatter and flatter. An apparatus for measuring the average center surface roughness (SRa) is not particularly limited, and can be suitably selected according to the object. For example, SURFCOM 570A-3DF (made by Tokyo Seimitsu) can be used for measuring the average center surface roughness (SRa) at the cutoff wavelength of 0.3 mm to 0.4 mm, based on the following measuring condition and analysis condition.

Measuring Condition and Analysis Condition
Scanning direction: MD direction of sample.
Measuring length: Machining paper direction (X-direction) 50 mm, and perpendicular direction (Y-direction) thereto 30 mm.
Measuring pitch: X-direction 0.1 mm, Y-direction 0.1 mm.
Scanning speed: 30 mm/sec.
Band pass filter: 0.3 mm to 0.4 mm.

Herein, as long as being 0.9 μm or less at the cutoff wavelength of 0.3 mm to 0.4 mm, the average center surface roughness (SRa) is not particularly limited, and can be suitably selected according to the object. For example, the average center surface roughness (SRa) is preferred to be 0.8 μm or less, and more preferably 0.75 μm or less.

As long as the average center surface roughness (SRa) is satisfied on at least a first face of the paper, it is not particularly limited. When the paper is used as an image-recording material support, however, the average center surface roughness (SRa) is to be preferably satisfied on the side (of the image-recording material support) to be formed with an image-recording layer.

Under the present invention, a paper according to its second aspect comprises a raw paper. An Oken type smoothness S (second) on at least one face of the paper, and a density ρ (g/cm³) of the paper satisfy an expression S^{1/2}/ρ³≧15.

Hereinafter, the value calculated by the above expression S^{1/2}/ρ³ are, as the case may be, referred to as “H index.”

The Oken type smoothness S (second) is defined based on the method B (measuring method) specified in JAPAN TAPPI No. 5, and is obtained for example, by a smoothness (roughness) test using an Oken type smoothness air-transparency tester.

As long as the above is satisfied, the Oken type smoothness S (second) is not particularly limited, and can be suitably selected according to the object. For example, the Oken type smoothness S is preferred to be 100 sec or more, and more preferably 150 sec or more. An upper limit of the Oken type smoothness S is not particularly limited, ordinarily preferred to be 600 sec or less, and more preferably 500 sec or less.

A face having the Oken type smoothness S (second) satisfying the above can be only on one side of the paper, or on both sides of the paper. When the paper is used as an image-recording material support, however, the Oken type smoothness S (second) is preferably satisfied on the side to be formed with an image-recording layer, from the viewpoint of forming high-quality image.

As long as the above is satisfied, the density ρ (g/cm³) is not particularly limited, and can be suitably selected according to the object. For example, the density ρ (g/cm³) is preferred to be 0.85 g/cm³ to 1.05 g/cm³. The density less than 0.85 g/cm³ may cause insufficient planarity, and more than 1.05 g/cm³ may cause an insufficient rigidity (stiffness).

As long as being 15 or more, the H index calculated by the above expression S^{1/2}/ρ³ is not particularly limited and can be suitably selected according to the object. For example, the H index is preferred to be 16 or more, and more preferably 17 or more. The H index less than 15 may cause an insufficiency to at least one of the planarity and the rigidity (stiffness). An upper limit of the H index is not particularly specified, and can be suitably selected according to the object. For example, the upper limit of the H index is preferred to be 23 or less, and more preferably 19 or less.

Moreover, an Oken type smoothness Si (second) on a face of the paper that is subjected to a press dry treatment, and a density Pi (g/cm³) of the paper after the press dry treatment satisfy an expression S^{1/2}/ρ³≧15.

The paper is not particularly limited, and can be suitably selected according to the object. For example, the paper can be raw paper, synthetic paper, a synthetic resin sheet, coat paper, laminate paper, and the like.

The above raw paper is not particularly limited, and can be suitably selected according to the object. Specifically, the raw paper can be preferred to be those described on page 223 to page 224 of Society of Photographic Science and Technology of Japan “Fundamentals of Photography (shashin kougaku no kiso)—Silver Salt Photograph” published by Corona (Showa 54 [1979]).

As long as being a known material used for the support, the raw paper is not particularly limited, and can be suitably selected according to the object. Examples of the raw paper include natural pulps such as needle-leaf tree pulp, broad-leaf tree pulp and the like, a mixture of the above natural pulp(s) with a synthetic pulp(s), and the like.

The pulp usable for a raw material of the raw paper is preferred to be the broad-leaf tree pulp, from the viewpoint of simultaneously improving planarity, dimension stability and the like of the raw paper, in a good balance and to a sufficient level. The needle-leaf tree is, however, also usable.

Examples of the broad-leaf tree pulps include broad-leaf tree bleached kraft pulρ (LBKP), broad-leaf tree sulfite pulρ (LBSP) and the like. Among these, the broad-leaf tree bleached kraft pulρ (LBKP) is preferable.

A content of the broad-leaf tree pulp relative to the paper is not particularly limited, and can be suitably selected according to the object. For example, the content is preferred to be 50% by mass or more, more preferably 60% by mass or more, and still more preferably 75% by mass or more.

Examples of the needle-leaf tree pulp include needle-leaf tree bleached kraft pulp (NBKP) and the like.

As the above pulp, it is preferable to use mainly a broad-leaf tree pulp that originally has a short fiber length.

A beater, a refiner or the like can be used for beating the pulp. When necessary, various types of additives can be added to a pulp slurry (hereinafter referred to as “pulp paper material” as the case may be) which can be obtained after beating the pulp. Examples of the additives include filling material, dry paper reinforcer, sizing agent, wet paper reinforcer, fixing agent, pH regulator, other agents and the like.

Examples of the filling materials include calcium carbonate, clay, white clay, kaolin, white earth, talc, titanium oxide, diatomaceous earth, barium sulfate, aluminum hydroxide, magnesium hydroxide and the like.

Examples of the dry paper reinforcers include cationic starch, cationic polyacrylamide, anionic polyacrylamide, amphoteric polyacrylamide, carboxy-modified polyvinyl alcohol and the like.

Examples of the sizing agents include rosin derivatives such as aliphatic salts, rosin, maleic rosin or the like; paraffin wax, alkyl ketene dimer, alkenyl succinic anhydride (ASA), epoxy aliphatic amide, and the like.

Examples of the wet paper reinforcers include polyamine polyamide epichlorohydrin, melamine resin, urea resin, epoxy polyamide resin and the like.

Examples of the fixing agents include polyfunctional metal salts such as aluminum sulfate, aluminum chloride, or the like; cationic polymers such as cationic starch, or the like.

Examples of the pH regulators include caustic soda, sodium carbonate and the like.

Examples of other agents include defoaming agents, dyes, slime control agents, fluorescent whitening agents and the like.

Moreover, softeners can also be added when necessary. For the softeners, ones which are disclosed on pp. 554-555 of Paper and Paper Treatment Manual (Shiyaku Time Co., Ltd.) (1980) and the like can be used, for example.

Each of the above additives and the like can be used either alone or in combination of two or more. The amount of each of the additives into the pulp paper material is not particularly limited, and can be suitably selected according to the object, 0.1% by mass to 1.0% by mass is preferred ordinarily.

Moreover, the pulp paper material which is the pulp slurry to which the various types of additives are added if necessary is to be machined by using paper-making machines such as a manual paper-making machine, a long-net paper-making machine, a round-net paper-making machine, a twin-wire machine, a combination machine, and thereafter is dried for preparing the raw paper. When necessary, either before or after the drying, a surface sizing treatment can be carried out.

Examples of surface sizing treatment liquids used for the surface sizing treatment include at least one metal salt selected from alkaline metal salt and alkaline earth metal salt, water-soluble high molecular compound, fluorescent whitening agent, waterproof substance, pigment, dye and the like.

As the at least one the metal salt selected from the alkaline metal salt and the alkaline earth metal salt, those described above can be used.

The water-soluble high molecular compound is not particularly limited, and can be suitably selected according to the object. Examples of the water-soluble high molecular compounds include polyvinyl alcohol, carboxy-modified polyvinyl alcohol, carboxymethyl cellulose, hydroxyethyl cellulose, cellulose sulfate, polyethylene oxide, gelatin, cationic starch, casein, sodium polyacrylate, sodium salt of styrene-maleic acid anhydride copolymer, sodium polystyrene sulfonate and the like. Among these, polyvinyl alcohol, carboxy-modified polyvinyl alcohol, carboxymethyl cellulose, hydroxyethyl cellulose, cellulose sulfate, polyethylene oxide, and gelatin are preferable, and particularly polyvinyl alcohol (PVA) is more preferable.

A content of the water-soluble high molecular compound is preferably 0.5 g/m² to 2 g/m².

Examples of the fluorescent whitening agents include stilbene compounds, coumarin compounds, biphenyl compounds, benzo-oxazoline compounds, naphthalimide compounds, pyrazoline compounds, carbostyryl compounds, carbostyryl compounds, diamino stilbene disulfonic acid derivative, imidazole derivative, coumarin derivative, triazole derivative, carbazole derivative, pyridine derivative, naphthalic acid derivative, imidazolone derivative and the like. Among these, stilbene compound is preferable.

A content of the florescent whitening agent is not particularly limited, and 0.01% by mass to 0.5% by mass is preferable, more preferably 0.02% by mass to 0.2% by mass.

Examples of the waterproof materials include latex emulsions such as styrene-butadiene copolymer, ethylene-vinyl acetate copolymer, polyethylene, vinylidene chloride copolymer or the like; polyamide polyamine epichlorohydrin and the like.

Examples of the pigments include calcium carbonate, clay, kaolin, talc, barium sulfate, titanium oxide and the like.

As for the above-mentioned raw paper, to improve the rigidity (stiffness) and dimension stability of the image-recording material support, it is preferred that the ratio (Ea/Eb) of the longitudinal Young's modulus (Ea) to the lateral Young's modulus (Eb) is within a range from 1.5 to 2.0. When the ratio (Ea/Eb) is less than 1.5 or more than 2.0, the rigidity (stiffness) and dimension stability of the image-recording material support tend to deteriorate, and may cause inconveniences to traveling property during transportation.

It has been found that, in general, the “rigidity (stiffness)” of the paper differs based on differences in the way the paper is beaten, and the elasticity modulus of paper from paper-making after beating can be used as an important indication of the “rigidity (stiffness)” of the paper. The elasticity modulus of the paper can be calculated from the following equation by using the relation of the density and the dynamic modulus which shows the physical properties of a viscoelastic object, and by measuring the velocity of sound propagation in the paper using an ultrasonic oscillator.
E=ρc²(1−n²)
where “E” represents dynamic modulus; “ρ” represents density; “c” represents the velocity of sound in paper; and “n” represents Poisson's ratio.

As n=0.2 or so in a case of ordinary paper, there is not much difference in the calculation, even when the calculation is performed by the following equation:
E=ρc²

Accordingly, when the density of the paper and acoustic velocity can be measured, the elasticity modulus can easily be calculated. In the above equation, when measuring acoustic velocity, various instruments known in the art may be used, such as a Sonic Tester SST-110 (Nomura Shoji Co., Ltd.) or the like.

The thickness of the raw paper is not particularly limited, and can be suitably selected according to the object, and it is preferably 30 μm to 500 μm, and more preferably 50 μm to 300 μm, and still more preferably 100 μm to 250 μm. The basis weight of the raw paper is not particularly limited, and can be suitably selected according to the object, and for example, it is preferably from 50 g/m² to 250 g/m², and more preferably from 100 g/m² to 200 g/m².

Press Dry Treatment

The press dry treatment is not particularly limited and may be suitably selected according to the object, provided that it can heat and dry the pulp paper material while pressing it to soften paper fibers and allow the fibers to come close to each other. For example, the pulp paper material is dehydrated using a manual paper-making machine and then its water content before press dry treatment is adjusted to 30% to 70% using a wet press apparatus or the like, thereby forming a sheet of raw paper. Then, at a drying temperature from 100° C. to 200° C., a press dry treatment is performed on the raw paper, specifically, on a side (of the raw paper whose water content is adjusted) to be formed with an image-recording layer.

Water content of the raw paper (wet paper) before the press drying treatment is preferably 30% to 70%, more preferably 40% to 60%.

The water content of the raw paper after the press drying treatment is not particularly limited, and may be suitably selected according to the object, preferably it is 10% or less, and more preferably 3% to 8%.

The drying temperature on the raw paper's side to be formed with the image-recording layer is preferably from 100° C. to 200° C., more preferably from 110° C. to 180° C. When the above drying temperature is lower than 100° C., a sufficient amount of water does not evaporate and bonding among fibers becomes weak, which sometimes results in unfavorable paper force. When it is higher than 200° C., sizing property and planarity may become insufficient due to the relationship with additives.

The pressure of the press dry treatment is preferably from 0.05 MPa to 1.5 MPa, and more preferably from 0.05 MPa to 0.5 MPa.

The pressure of the press dry treatment less than 0.05 MPa may make the planarity insufficient due to reduced fluidity of the resin, while more than 1.5 MPa may cause partly uneven density.

The density of the raw paper after the press dry treatment is preferably 0.85 g/cm³ to 1.05 g/cm³, and more preferably 0.9 g/cm³ to 1.05 g/cm³. The above density of the raw paper less than 0.85 g/cm³ may make the planarity insufficient.

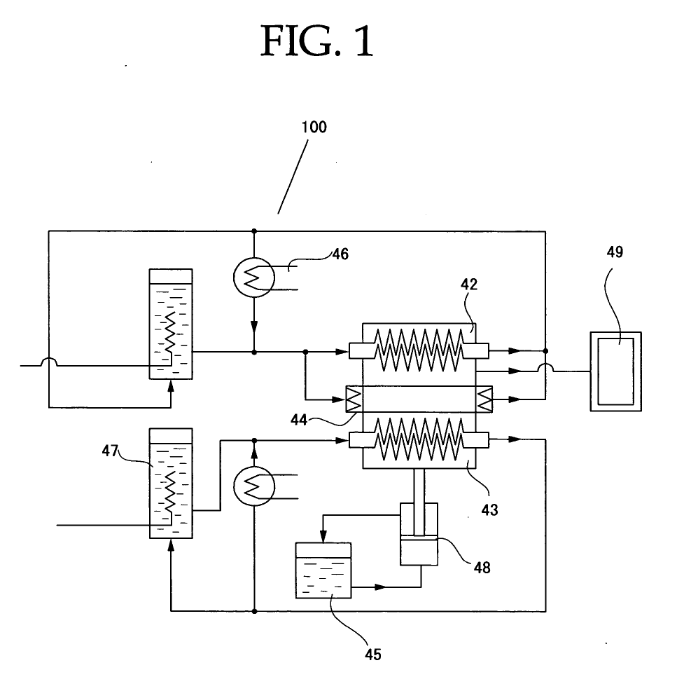

The apparatus with which the press dry treatment is performed is not particularly limited and may be suitably selected according to the object. For example, a press dry treatment apparatus 100 based on Condebelt drying technique as shown in FIG. 1 is preferable as an apparatus which is not incorporated in a production line and oriented towards laboratory use.

The press dry treatment apparatus 100 has an upper plate 42, a lower plate 43, a jacket 44 provided between the upper plate 42 and the lower plate 43, and one or more other members when necessary.

Drying with the press dry treatment apparatus 100 is performed by placing a sheet of wet paper (not shown) which has been prepared by dehydrating pulp paper material with a manual paper-making machine and a wet press apparatus or the like in a jacket 44 which is impermeable to air; and thermally drying and pressuring the sheet with the upper plate 42 and lower plate 43 the temperatures of which are each controlled by electrically heated oil 47. During pressure drying, water vapor and the like which are generated at the wet paper are removed by a vacuum tank 49. Pressuring is performed by applying pressure to the lower plate 43 with a pressing unit 48 using hydraulic oil 45. Further, during pressure drying, cooling water 46 is configured to flow through the apparatus.

For example, STATIC CONDEBELT (manufactured by VALMET) which is a static press dry equipment may be used as one of such press dry treatment apparatuses.

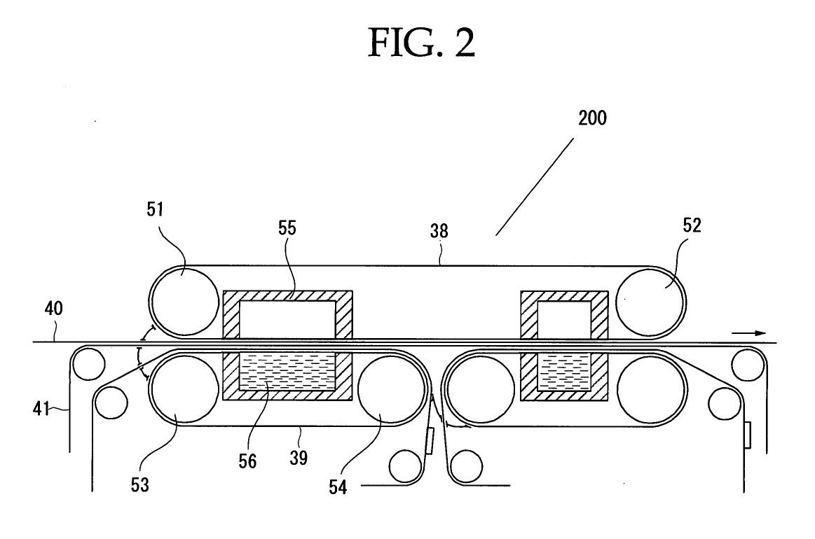

On the other hand, when the press dry treatment is to be incorporated into a production line so that it can be performed continuously, a press dry treatment apparatus 200 as shown in FIG. 2 is preferable.

Referring to FIG. 2, the press dry treatment apparatus 200 includes a first endless belt 38 and a second endless belt 39 which are impermeable to air and conduct heat well, a first set of turning rollers 51 and 52 around which the first endless belt 38 is arranged to turn, and a second set of turning rollers 53 and 54 around which the second endless belt 39 is arranged to turn.

The first endless belt 38 and the second endless belt 39 are arranged in such a way that they run part of the way parallel with each other so that they form a drying zone between themselves.

A heating chamber 55 heats the first endless belt 38, and a cooling chamber 56 cools the second endless belt 39.

Then, dehydrated wet paper 40 and at least one fabric 41 which forms an endless loop are introduced between the first endless belt 38 and the second endless belt 39 in such a way that the dehydrated wet paper 40 is in contact with the heated first endless belt 38 and the fabric 41 is positioned between the dehydrated wet paper 40 and both of the cooled second endless belt 39 and guide rollers and accordingly the wet paper 40 is pressure dried.

The details of the press dry treatment apparatus 200 are described in JP-A No. 2000-500536.

According to this press dry treatment apparatus, it is possible to achieve a good press dry result more efficiently than with conventional ones.

By the press dry treatment described above, the sheet of raw paper has better density, elasticity modulus, tensile strength, strength and the like so as to provide an image-recording material support which is excellent in dimension stability and planarity and with which curl is less likely to occur. Accordingly, by using the above image-recording material support, it is possible to provide high-quality images.

To a cast coat layer which is provided on the raw paper after the press dry treatment, when necessary, a calender treatment by means of a super calender and the like may be carried out.

Calender Treatment

The paper is preferred to be subjected to the calender treatment after the press dry treatment.

The calender treatment is not particularly limited, and can be suitably selected according to the object. In this case, however, a high temperature soft calender treatment is preferred, and temperature of the surface of the metal roll is preferably 110° C. or more, more preferably 150° C. or more, and still more preferably 250° C. or more. An upper limit of the temperature is for example 300° C.

Carrying out the calender treatment can obtain paper having high gloss.

As described above, the paper under the present invention has high planarity and excellent gloss, and can be used for various applications. Particularly, the paper is preferably to be used for the image-recording material support described below.

(Image-Recording Material Support)

Under the present invention, an image-recording material support according to its first aspect comprises a paper which comprises a raw paper. The paper satisfies at least one of the following conditions (i) and (ii): (i) the paper has an inner bonding strength of 160 ml or more specified in Japan Technical Association of the Pulp and Paper Industry No. 54, and an average center surface roughness on at least one face of the paper is 0.9 μm or less at a cutoff wavelength of 0.3 mm to 0.4 mm, and (ii) an Oken type smoothness S (second) on the at least one face of the paper, and a density ρ (g/cm³) of the paper satisfy an expression S^{1/2}/ρ³≧15.

As described above, the image-recording material support according to its first aspect is preferably to be subjected to at least one of the press dry treatment and the calender treatment.

Under the present invention, an image-recording material support according to its second aspect comprises a raw paper subjected to a press dry treatment to thereby form a press-dried face; and a coat layer. The coat layer is made by subjecting the press-dried face of the raw paper to a surface treatment using a member with a smooth surface.

Moreover, the image-recording material support according to its second aspect comprises another layer, when necessary.

Formation of Coat Layer and Transfer of Surface Appearance

For formation of coat layer and transfer of surface appearance, a method is proposed of abutting the coat layer to a smooth surface of a member, to thereby transfer the surface appearance. In this case, the smooth surface of the member is preferred to be a mirror face of a metal drum.

The method for transferring the surface appearance of the smooth surface to the coat layer is not particularly limited, and can be suitably selected according to the object. For example, a cast coat method is preferable. In the cast coat method, a cast coating solution is to be applied to the raw paper which was subjected to the press dry treatment, then, in a state that the entire coat layer or the surface of the coat layer is wet or plastic, the coat layer is to be crimped to a heated finished surface of the metal cast drum. With this, drying the coat layer and the photographing of the finished surface can be simultaneously achieved.

The cast coast method is not particularly limited, and can be suitably selected according to the object, examples including wet cast method, gelatinization cast method, rewet cast method and the like. Each of the above methods is common in that photographing of the surface appearance of the cast drum with the mirror face can obtain a high-gloss surface of the coat layer. The above methods have the following characteristics, respectively, up to a process that the cast coating solution applied to the raw paper is crimped to the cast drum.

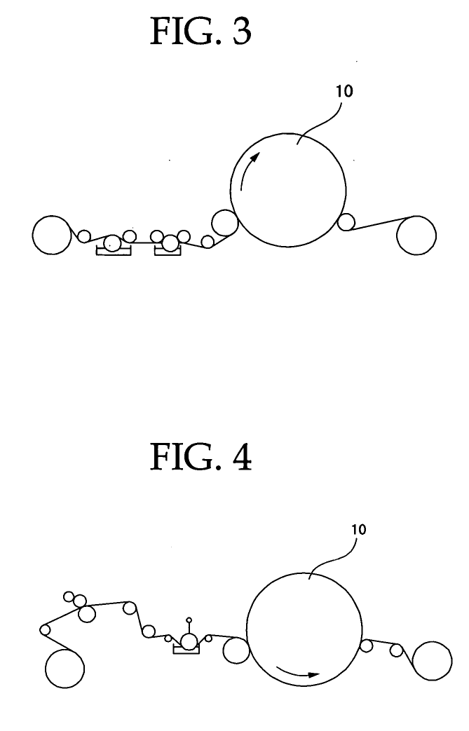

In FIG. 3, the wet cast method (direct method) is shown. In a state that the cast coating solution applied to the raw paper (which was subjected to the press dry treatment) is not dried at all, the cast coating solution is crimped to a cast drum 10 (with a mirror face), to thereby transfer the surface appearance of the cast drum 10.

In FIG. 4, the gelatinization cast method is shown. The cast coating solution applied to the raw paper (which was subjected to the press dry treatment) is treated with a coagulation liquid, then the cast coating solution is gelatinized (free from fluidity) and is crimped to the cast drum 10 (with the mirror face), to thereby transfer the surface appearance of the cast drum 10.

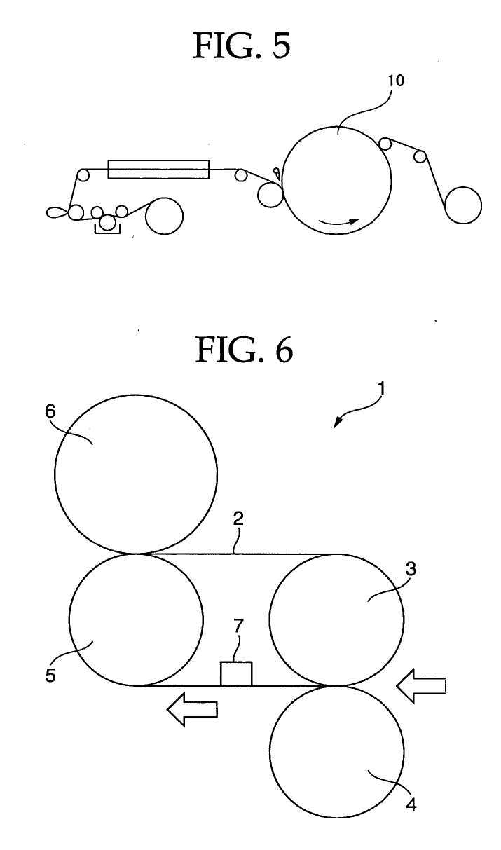

In FIG. 5, the rewet cast method is shown. The cast coating solution applied to the raw paper (which was subjected to the press dry treatment) is dried in advance, then a rewet liquid having a main component of water is applied to a dried coat face to thereby make a coat material swelled or plasticized, then the cast coat liquid is crimped to the cast drum 10 (with the mirror face) and is dried, to thereby obtain cast coat paper which is smooth and highly glossy. Compared with the wet cast method and the gelatinization cast method, the rewet cast method is good in that the productivity is high.

In each of the wet cast method, the gelatinization cast method and the rewet cast method, the cast drum is the one that is made of metal having a cylindrical outer periphery mirror-machined, and ordinarily is heated at 80° C. to 150° C. for use.

The coat layer to be disposed at least a first face of the raw paper which was subjected to the press dry treatment is obtained by applying thereto the cast coating solution (including at least a pigment and a binder) and drying it.

The pigment is not particularly limited, and can be suitably selected according to the object. Examples of the pigments include silica, alumina, calcium carbonate, magnesium carbonate, barium sulfate, aluminum hydroxide, kaolin, talc, clay, titanium dioxide, zinc oxide, various plastic pigments and the like, to be used either alone or in combination of two ore more.

The binder is not particularly limited, and can be suitably selected according to the object. Examples of the binder include starches such as oxidized starch, esterified starch and the like; cellulose derivatives such as carboxymethyl cellulose, hydroxyethyl cellulose and the like; proteins such as gelatin, casein, soybean albumin and the like; polyvinyl alcohol, polyvinyl pyrrolidone, acrylic resin, styrene-acrylic resin, vinyl acetate resin, vinyl chloride resin, urea resin, urethane resin, alkyd resin, polyester resin, polycarbonate resin, styrene-butadiene latex and derivatives thereof. The above binders can be used either alone or in combination of two or more. Use of a plural types of the binders in combination may have proper variations according to property of the cast coating solution, prescription, application of the cast coat paper and the like.

A content of the binder is preferably 1% by mass to 10% by mass (solid conversion) to the entire amount of the coating solution, and more preferably 3% by mass to 8% by mass.

Blend ratio of the pigment to the binder (P/B=dry blend mass part number of pigment/dry blend mass part number of binder) is not particularly limited, and can be suitably selected according to the object, preferably 1.5 to 15, and more preferably 3 to 7. Greater blend ratio may lose the smoothness.

To the cast coating solution, the following assistants can be applied when necessary: known assistants such as pigment dispersant, water holding agent, thickener, antifoaming agent, preservative, colorant, waterproof agent, wetting agent, plasticizer, fluorescent paint, ultraviolet absorber, oxidation inhibitor, cationic high molecular electrolyte and the like.

Examples of coaters for the cast coating solution include blade coater, air knife coater, roll coater, comma coater (made by Kobayashi Engineering Works, Ltd.), brush coater, squeeze coater, curtain oater, kiss coater, bar coater, gravure coater and the like.

The amount of the cast coating solution (solid conversion) is preferably 2 g/m² to 50 g/m², more preferably 3 g/m² to 30 g/m².

Examples of the methods for drying the coat layer include air floating drier, infrared drier, cylinder drier and the like.

In the case that a cast coat layer is formed by the rewet cast method, examples of the additives of rewet liquids include ammonium salt, polyamide resin, phosphor compound such as hexametaphosphate, amide compound, fluoride, zinc sulfate, calcium formate, and the like.

In the case that the cast coat layer is to be formed by the coagulation method, examples of coagulants added to the coagulation liquid include salts such as formic acid, acetic acid, citric acid, tartaric acid, lactic acid, hydrochloric acid, sulfuric acid, carbonic acid with calcium, zinc, magnesium, sodium, potassium, barium, lead, cadmium, ammonium, and the like; boric acids such as borax; and the like. The above coagulants can be used either alone or in combination of two or more.

The cast coat layer can be formed on one side of the raw paper, or on both sides of the raw paper. The number of cast coat layers is not limited to one, instead, a multiple-layer structure is allowed.

The image-recording material support under the present invention is, as described above, so constituted that the coat layer is formed at least on the side (of the raw paper which was subjected to the press dry treatment) to be formed with the image-recording layer, and the coat layer is allowed to abut on the smooth surface to thereby transfer the surface appearance. With this, the image-recording material support is excellent in surface smoothness and is extremely excellent in gloss.

The average center surface roughness (SRa) on the side (of the image-recording material support) to be formed with the image-recording layer is preferably 0.5 μm or less at a cutoff wavelength of 5 mm to 6 mm, more preferably 0.1 μm to 0.4 μm. The average center surface roughness (SRa) over 0.5 μm may cause an insufficient planarity after the coating.

Herein, the average center surface roughness (SRa) can be obtained by scanning three-dimensionally a plane having a certain roughness, and therefore is different from an average center line roughness (Ra) that can be obtained by scanning a linear roughness of a plane. For example, SURFCOM 570A-3DF (made by Tokyo Seimitsu) can be used for measuring the average center surface roughness (SRa) at the cutoff wavelength of 5 mm to 6 mm, based on the following measuring condition and analysis condition.

Measuring Condition and Analysis Condition

Scanning direction: MD direction of sample.
Measuring length: Machining paper direction (X-direction) 50 mm, and perpendicular direction (Y-direction) thereto 30 mm.
Measuring pitch: X-direction 0.1 mm, Y-direction 0.1 mm.
Scanning speed: 30 mm/sec.
Band pass filter: 5 mm to 6 mm.

In terms of surface smoothness and gloss of the image-recording material support: specifically, 20% or more at 20-degree gloss is preferable, and 40% or more at 20-degree gloss is more preferable. The gloss less than 20% may cause an insufficient gloss after the image formation.

The above 20-degree gloss can be measured based on JIS Z8741.

In terms of waterproof of the image-recording material support: specifically, Cobb sizing water absorbency (30 sec) is preferred to be 10 g/m² or less, more preferably 5 g/m² or less, and still more preferably 4 g/m² or less.

The above Cobb sizing water absorbency can be obtained by measuring the amount of water absorbency when a pure water has a contact with a sample for 30 seconds pursuant to JIS P8140.

(Image-Recording Material)

The image-recording material under the present invention includes at least a support and an image-recording layer formed on the support. The above support is the image-recording material support under the present invention.

The image-recording material differs with the use and type thereof, and examples include an electrophotographic material, heat sensitive material, inkjet-recording material, sublimation transfer material, silver salt photographic material, heat transfer material and the like.

<Electrophotographic Material>

An electrophotographic material includes an image-recording material support and at least one toner image-receiving layer which is disposed on at least one surface of this support under the present invention. When necessary, the electrophotographic material may further include other layers which may be suitably selected. Examples of the other layers include a surface protection layer, an intermediate layer, an underlayer, a cushion layer, a static control (prevention) layer, a reflection layer, a color tone adjusting layer, a storage property improvement layer, an antistick layer, an anticurl layer, a smoothing layer and the like. These layers may have a single-layer structure or a laminated structure.

[Toner Image-Receiving Layer]

The toner image-receiving layer receives a color toner or a black toner and forms an image. The toner image-receiving layer has a function to receive toner which forms an image from a developing drum or an intermediate transfer by (static) electricity or pressure in a transferring step, and to fix the image by heat or pressure in a fixing step.

The material of the toner image-receiving layer contains at least a polymer, when necessary, and various additives to be added for improving thermodynamic properties of the toner image-receiving layer. Examples of the additives include releasing agent, plasticizer, filler, cross-linking agent, charge control agent, emulsifier, dispersant and the like.

Polymer for Toner Image-Receiving Layer

Polymer for toner image-receiving layer is not particularly limited, and can be suitably selected according to the object, examples thereof including (1) polyolefin resin, (2) polystyrene resin, (3) acrylic resin, (4) polyvinyl acetate or derivatives thereof, (5) polyamide resin, (6) polyester resin, (7) polycarbonate resin, (8) polyether resin (or acetal resin), (9) other resins. The above polymers may be used either alone or in combination of two or more. Among the above, in terms of embedding of the toner, preferably used are styrene resin, acrylic resin, and polyester resin which have high coagulation energy.

Examples of (1) polyolefin resins include polyolefin resins such as polyethylene, polypropylene and the like; copolymer resins of olefins (such as ethylene, propylene and the like) with other vinyl monomers; and the like. Examples of the above copolymer resins of olefins with other vinyl monomers include ethylene-vinyl acetate copolymer; an ionomer resin which is a copolymer of olefins with acrylic acid or methacrylic acid; and the like. Herein, examples of the derivatives of the polyolefin include chlorinated polyethylene, chlorosulfonated polyethylene and the like.

Examples of (2) polystyrene resins include polystyrene resin, styrene-isobutylene copolymer, acrylonitrile-styrene copolymer (AS resin), acrylonitrile-butadiene-styrene copolymer (ABS resin), polystyrene-maleic anhydride resin and the like.

Examples of (3) acrylic resins include polyacrylic acid or esters thereof, polymethacrylic acid or esters thereof, polyacrylonitrile, polyacrylamide and the like.

Examples of esters of polyacrylic acid include homopolymer or polytypic copolymer of acrylic acid. Examples of esters of acrylic acid include methyl acrylate, ethyl acrylate, acrylic acid n-butyl, isobutyl acrylate, dodecyl acrylate, acrylic acid n-octyl, acrylic acid 2-ethylhexyl, acrylic acid 2-chloroethyl, phenyl acrylate, α-chloroacrylic acid methyl and the like.

Examples of esters of polymethacrylic acid include homopolymer or polytypic copolymer of methacrylic acid. Examples of esters of methacrylic acid include methyl methacrylate, ethyl methacrylate, butyl methacrylate and the like.

Examples of (4) polyvinyl acetates or derivatives thereof include polyvinyl acetate and polyvinyl alcohol which is obtained by saponifying polyvinyl acetate, polyvinyl acetal resin obtained by reacting polyvinyl alcohol with aldehyde (for example, formaldehyde, acetaldehyde, butylaldehyde and the like), and the like.

Examples of (5) polyamide resins include polycondensation of diamine with dibasic acid such as 6-nylon, 6,6-nylon and the like.

(6) polyester resin is produced by polycondensation of acid composition with alcohol composition. The acid composition is not particularly limited, and can be suitably selected according to the object. Examples of (6) polyester resins include maleic acid, fumaric acid, citraconic acid, itaconic acid, glutaconic acid, phthalic acid, terephthalic acid, isophthalic acid, succinic acid, adipic acid, sebacic acid, azelaic acid, malonic acid, n-dodecenyl succinate, isododecenyl succinate, n-dodecyl succinate, isododecyl succinate, n-octenyl succinate, n-octyl succinate, isooctenyl succinate, isooctyl succinate, trimellitic acid, pyromellitic acid, acid anhydrides thereof, low alcohol esters thereof, and the like.

The above alcohol composition is not particularly limited, and can be suitably selected according to the object. Diatomic alcohol is preferable. Examples of fatty series diols include ethylene glycol, diethylene glycol, triethylene glycol, 1,2-propylene glycol, 1,3-propylene glycol, 1,4-butanediol, neopentyl glycol, 1,4-butanediol, 1,5-pentanediol, 1,6-hexanediol, 1,4-cyclohexanedimethanol, dipropylene glycol, polyethylene glycol, polypropylene glycol, polytetramethylene glycol and the like. Examples of alkylene oxide adducts of bisphenol A include polyoxypropylene, (2.2)-2,2-bis (4-hydroxyphenyl) propane, polyoxypropylene (3.3)-2,2-bis (4-hydroxyphenyl) propane, polyoxyethylene (2.0)-2,2-bis (4-hydroxyphenyl) propane, polyoxypropylene (2.0)-polyoxyethylene (2.0)-2,2-bis (4-hydroxyphenyl) propylene, polyoxypropylene (6)-2,2-bis (4-hydroxyphenyl) propane and the like.

A general example of (7) polycarbonate resin is polycarbonate ester which is obtained by bisphenol A and phosgene.

Examples of (8) polyether resins (or acetal resin) include polyether resins such as polyethylene oxide, polypropylene oxide and the like; acetal resins such as polyoxymethylene as ring-opening polymerization and the like; and the like.

Examples of (9) other resins include polyurethane resin of polyaddition.

As the polymer for the toner image-receiving layer, those satisfying toner image-receiving layer properties (to be described afterward) are preferable in a state that the toner image-receiving layer is formed. Those satisfying the above properties alone are more preferable. Use of two or more resins with different toner image-receiving layer properties (to be described afterward) is also preferable.

As the polymer for the toner image-receiving layer, those having greater molecular weight are preferable than the thermoplastic resin used for the toner. The relative molecular weight is, however, not limited to the above, in view of thermodynamic properties of the thermoplastic resin used for the toner relative to the polymer for the toner image-receiving layer. For example, when the polymer for the toner image-receiving layer is higher in terms of softening temperature than the thermoplastic resin used for the toner, preferably, the molecular weight is equal or as the case may be the polymer for the toner image-receiving layer has smaller molecular weight.

As the polymer for the toner image-receiving layer, it is preferable to use a mixture of resins which have the same composition and have different average molecular weights from each other. Japanese Patent Application Laid-Open (JP-A) No. 08-334915 discloses a preferable relation, in terms of molecular weight, between the polymer for the toner image-receiving layer and the thermoplastic resin used for the toner.

In terms of distribution of molecular weights, the polymer for the toner image-receiving layer is preferably wider than the thermoplastic resin used for the toner.

Preferably, the polymer for the toner image-receiving layer has properties disclosed in JP-A No. 05-127413, JP-A No. 08-194394, JP-A No. 08-334915, JP-A No. 08-334916, JP-A No. 09-171265 and JP-A No. 10-221877.

The polymer for the toner image-receiving layer is excellent in environmental property and workability since no organic solvent is discharged at coating-drying steρ (i). Many releasing agents such as wax are unlikely to be solved in solvent at room temperature, and are often dispersed, prior to usage, in solvent (water and organic solvent). Water dispersing form is more stable and is more adaptive to production steps. Moreover, an aqueous coating is more likely to cause bleeding of wax on the surface in the process of coating-drying, thus making it easier to obtain the effect of the releasing agent (antioffset property, adhesive resistance and the like). For the above reasons, aqueous resins such as water-dispersible polymer, water-soluble polymer and the like are preferably used.

The above aqueous resins, provided that they are either the water-dispersible polymer or the water-soluble polymer, are not particularly limited in terms of composition, bonding structure, molecular structure, molecular weight, molecular weight distribution, form and the like, and can be suitably selected according to the object. Examples of aqueous group of the above polymers include sulfonic group, hydroxyl group, carboxylic group, amino group, amide group, ether group and the like.

The above water-dispersible polymer can be made, for example, by suitably selecting from the following and combining two or more of them: i) resins made by dispersing in water the polymers for toner image-receiving layer numbered by (1) to (9) above, ii) emulsions made by dispersing in water the polymers for toner image-receiving layer numbered by (1) to (9) above, iii) copolymer thereof, iv) mixture thereof, and v) cationic modified product.

The water-dispersible polymer can be suitably synthesized for use, or those commercially available are usable. Examples of commercial products of the water-dispersible polymers include polyester resins such as Vylonal series by Toyobo Co., Ltd., Pesresin A series by Takamatsu Oil & Fat Co., Ltd., Tuftone UE series by Kao Corp., Nichigo Polyester WR series by Nippon Synthetic Chemical Industry Co., Ltd., Elitel series by Unitika Ltd. and the like; and acrylic resins such as Hiros XE, KE, and PE series by Seiko Chemical Industries Co., Ltd., Jurymer ET series by Nihon Junyaku Co., Ltd. and the like.

The water-dispersible emulsion can be any suitable emulsion that preferably has a volume-average particle diameter of 20 nm or more. Examples of such emulsions are water-dispersible polyurethane emulsions, water-dispersible polyester emulsions, chloroprene emulsions, styrene-butadiene emulsions, nitrile-butadiene emulsions, butadiene emulsions, vinyl chloride emulsions, vinylpyridine-styrene-butadiene emulsions, polybutene emulsions, polyethylene emulsions, vinyl acetate emulsions, ethylene-vinyl acetate emulsions, vinylidene chloride emulsions, and methyl methacrylate-butadiene emulsions. Among them, water-dispersible polyester emulsions are preferred.

The water-dispersible polyester emulsions are preferably self-dispersible aqueous polyester emulsions, of which self-dispersible aqueous carboxyl-containing polyester emulsions are typically preferred. The “self-dispersible aqueous polyester emulsion” herein means an aqueous emulsion containing a polyester resin that is self-dispersible in an aqueous solvent without the use of an emulsifier and the like. The “self-dispersible aqueous carboxyl-containing polyester emulsion” means an aqueous emulsion containing a polyester that contains carboxyl groups as hydrophilic groups and is self-dispersible in an aqueous solvent.

The self-dispersible aqueous polyester emulsion preferably satisfies the following requirements (1) to (4). This type of polyester resin emulsion is self-dispersible requiring no surfactant, is low in moisture absorbency even in an atmosphere at high humidity, exhibits less decrease in its softening point due to moisture and can thereby avoid offset in image-fixing and failures due to adhesion between sheets during storage. The emulsion is water-based and is environmentally friendly and excellent in workability. In addition, the polyester resin used herein readily takes a molecular structure with high coagulation energy. Accordingly, the resin has sufficient hardness (rigidity) during its storage but is melted with low elasticity and low viscosity during an image-fixing process for electrophotography, and the toner is sufficiently embedded in the toner-image-receiving layer to thereby form images having sufficiently high quality.
(1) The number-average molecular weight Mn is preferably from 5000 to 10000 and more preferably from 5000 to 7000.
(2) The molecular weight distribution (Mw/Mn) is preferably 4 or less, and more preferably 3 or less, wherein Mw is the weight-average molecular weight.
(3) The glass transition temperature Tg is preferably from 40° C. to 100° C. and more preferably from 50° C. to 80° C.
(4) The volume average particle diameter is preferably from 20 nm to 200 nm and more preferably from 40 nm to 150 nm.
(5) The content of the water-dispersible emulsion in the toner-image receiving layer is preferably from 10 percent to 90 percent by weight, and more preferably from 10 percent to 70 percent by weight.

The water-soluble polymer is not particularly limited, provided that the weight average molecular weight (Mw) is 400,000 or less, and can be suitably selected according to the object. The water-soluble polymer can be suitably synthesized for use, or commercially available product thereof can be used. Examples of the water-soluble polymers include polyvinyl alcohol, carboxy-modified polyvinyl alcohol, carboxymethyl cellulose, hydroxyethyl cellulose, cellulose sulfate, polyethylene oxide, gelatin, cationic starch, casein, sodium polyacrylate, sodium styrene-maleic acid anhydride copolymer: styrene-maleic acid anhydride copolymer), sodium polystyrene sulfonate and the like. Among the above, polyethylene oxide is preferable.

Examples of commercial products of water-soluble polymer include various Plascoat products by Goo Chemical Co., Ltd., Finetex ES series by Dainippon Ink and Chemicals Inc. and the like; and those of water-soluble acrylic resins include Jurymer AT series by Nihon Junyaku Co., Ltd., Finetex 6161 and K-96 by Dainippon Ink and Chemicals Inc., Hiros NL-1189 and BH-997 by Seiko Chemical Industries Co., Ltd. and the like.

Examples of the water-soluble resins are given on page 26 of Research Disclosure No. 17,643, page 651 of Research Disclosure No. 18,716, pp.873-874 of Research Disclosure No. 307,105, and JP-A No. 64-13546.

A content of the water-soluble polymer in the toner image-receiving layer is not particularly limited, and can be suitably selected according to the object, preferably 0.5 g/m² to 2 g/m².

The polymer for the toner image-receiving layer can be used in combination with other polymer materials, in this case, however, the polymer for the toner image-receiving layer is to be greater in content than the other polymer materials.

In the toner image-receiving layer, the content of polymer for the toner image-receiving layer is preferably 10% by mass or more, more preferably 30% by mass or more, still more preferably 50% by mass or over, and particularly preferably 50% by mass to 90% by mass.

Releasing Agent

The releasing agent can be blended to the toner image-receiving layer in order to prevent offset of the toner image-receiving layer. Various types of the releasing agent can be used and may be suitably selected according to the object as long as it is able to form a layer of the releasing agent on a surface of the toner image-receiving layer by being heated and melted at a fixing temperature so as to deposit and to remain on the surface of the toner image-receiving layer, and by being cooled and solidified so as to form a layer of the releasing agent, thereafter.

The releasing agent can be at least one of silicone compounds, fluorine compounds, waxes, and matting agents.

The releasing agent may be a compound described in Kaitei—Wakkusu no seishitsu to ouyou “Properties and Applications of Wax (Revised)” by Saiwai Publishing, or in the Silicone Handbook published by THE NIKKAN KOGYO SHIMBUN. Also, the silicone compounds, fluorine compounds and wax in the toners mentioned in Japanese Patent Application Publication UP-B) No. 59-38581, Japanese Patent Application Publication (JP-B) No. 04-32380, Japanese Patent (JP-B) No. 2838498, JP-B No. 2949558, Japanese Patent Application Laid-Open (JP-A) No. 50-117433, No. 52-52640, No. 57-148755, No. 61-62056, No. 61-62057, No. 61-118760, and JP-A No. O₂-42451, No. 03-41465, No. 04-212175, No. 04-214570, No. 04-263267, No. 05-34966, No. 05-119514, No. 06-59502, No. 06-161150, No. 06-175396, No. 06-219040, No. 06-230600, No. 06-295093, No. 07-36210, No. 07-43940, No. 07-56387, No. 07-56390, No. 07-64335, No. 07-199681, No. 07-223362, No. 07-287413, No. 08-184992, No. 08-227180, No. 08-248671, No. 08-248799, No. 08-248801, No. 08-278663, No. 09-152739, No. 09-160278, No. 09-185181, No. 09-319139, No. 09-319143, No. 10-20549, No. 10-48889, No. 10-198069, No. 10-207116, No. 11-2917, No. 11-44969, No. 11-65156, No. 11-73049 and No. 11-194542 may be used. These compounds can also be used in combination of two or more.

Examples of the silicone compounds include silicone oil, silicone rubber, silicone fine-particle, silicone-modified resin, reactive silicone compound and the like.

Such silicone oils include, for example, unmodified silicon oil, amino-modified silicone oil, carboxy-modified silicone oil, carbinol-modified silicone oil, vinyl-modified silicone oil, epoxy-modified silicone oil, polyether-modified silicone oil, silanol-modified silicone oil, methacrylic-modified silicone oil, mercapto-modified silicone oil, alcohol-modified silicone oil, alkyl-modified silicone oil, and fluorine-modified silicone oil.

Examples of the silicone-modified resins are silicone-modified resins derived from olefinic resins, polyester resins, vinyl resins, polyamide resins, cellulose resins, phenoxy resins, vinyl chloride-vinyl acetate resins, urethane resins, acrylic resins, styrene-acrylic resins, or copolymers comprising at least one of these constitutive monomers.

The fluorine compound is not particularly limited, and can be suitably selected according to the object. Examples of the fluorine compounds include fluorine oil, fluoro rubber, fluorine-modified resin, fluorine sulfonic acid compound, fluorosulfonic acid, fluorine acid compound or salt thereof, inorganic fluoride and the like.

The above waxes are largely classified into two, that is, natural wax and synthetic wax.

The natural wax is preferably at least one wax selected from vegetable wax, animal wax, mineral wax, and petroleum wax, among which vegetable wax is particularly preferable. The natural wax is also preferably a water-dispersible wax, from the viewpoint of compatibility and the like when an aqueous resin is used as the polymer for the toner image-receiving layer.

The vegetable wax is not particularly limited, and can be suitably selected from those known in the art. The vegetable wax may be a commercial product, or suitably synthesized.

Examples of the vegetable waxes include carnauba wax, castor oil, rapeseed oil, soybean oil, Japan tallow, cotton wax, rice wax, sugarcane wax, candellila wax, Japan wax, jojoba oil, and the like.

Examples of commercial product of the carnauba wax include EMUSTAR AR-0413 from Nippon Seiro Co., Ltd., and Cellusol 524 from Chukyo Yushi Co., Ltd, and the like.

Examples of commercial product of the castor oil include purified castor oil from Itoh Oil Chemicals Co., Ltd.

Of these, carnauba wax having a melting point of 70° C. to 95° C. is particularly preferable from the viewpoint of providing an electrophotographic image-receiving paper sheet which is excellent in antioffset properties, adhesive resistance, paper transporting properties, gloss, is less likely to cause crack and splitting, and is capable of forming high-quality image.

The animal wax is not particularly limited, and can be suitably selected from those known in the art. Examples of the animal waxes include bees wax, lanolin, spermaceti, whale oil, wool wax and the like.

The mineral wax is not particularly limited, and can be suitably selected from those known in the art. The mineral wax may be commercial product, or suitably synthesized.

Examples of the mineral waxes include montan wax, montan ester wax, ozokerite, ceresin and the like. Of these, montan wax having a melting point of 70° C. to 95° C. is particularly preferable from the viewpoint of providing an electrophotographic image-receiving paper sheet which is excellent in antioffset properties, adhesive resistance, paper transporting properties, gloss, is less likely to cause crack and splitting, and is capable of forming high-quality image.

The petroleum wax is not particularly limited, and can be suitably selected from those known in the art. The petroleum wax may be commercial product, or suitably synthesized.

Examples of the petroleum waxes include paraffin wax, a microcrystalline wax, and petrolatum and the like.

A content of the natural wax in the toner image-receiving layer (a surface) is preferably 0.1 g/m² to 4 g/m², and more preferably 0.2 g/m² to 2 g/m².

When the content is less than 0.1 g/m², the antioffset properties and the adhesive resistance may deteriorate. When the content is more than 4 g/m², the quality of an image may deteriorate because of the excessive amount of wax.

The melting point of the natural wax is preferably 70° C. to 95° C., and more preferably 75° C. to 90° C., from the viewpoint of antioffset properties and paper transporting properties.

The synthetic waxes are classified into synthetic hydrocarbon, modified wax, hydrogenated wax, and other grease synthetic wax. The synthetic wax is preferably a water-dispersible wax, from the viewpoint of compatibility when an aqueous thermoplastic resin is used as the thermoplastic resin in the toner image-receiving layer.

Examples of the synthetic hydrocarbons include Fischertropsch wax, polyethylene wax and the like.

Examples of the grease synthetic waxes include an acid amide compound (specifically, stearic acid amide and the like), an acid imide compound (specifically, anhydrous phthalic acid imide and the like) and the like.

The modified wax is not particularly limited, and can be suitably selected according to the object. Examples of the modified waxes include amine-modified wax, acrylic acid-modified wax, fluorine-modified wax, olefin-modified wax, urethane wax, alcohol wax and the like.

The hydrogenated wax is not particularly limited, and can be suitably selected according to the object. Examples of the hydrogenated waxes include cured castor oil, castor oil derivatives, stearic acid, lauric acid, myristic acid, palmitic acid, behenic acid, sebacic acid, undecylenic acid, heptyl acids, maleic acid, high grade maleic oils and the like.

The matting agent can be selected from any known matting agents. Solid particles used as the matting agent can be classified into inorganic particles and organic particles. Specifically, the inorganic matting agents may be oxides (for example, silicon dioxide, titanium oxide, magnesium oxide, and aluminum oxide), alkaline earth metal salts (for example, barium sulfate, calcium carbonate, and magnesium sulfate), silver halides (for example, silver chloride, and silver bromide), glass and the like.

Examples of the inorganic matting agents can be found in West German Patent No. 2529321, the U.K. Patent Nos. 760775, 1260772, and the U.S. Pat. Nos. 1,201,905, 2,192,241, 3,053,662, 3,062,649, 3,257,206, 3,322,555, 3,353,958, 3,370,951, 3,411,907, 3,437,484, 3,523,022, 3,615,554, 3,635,714, 3,769,020, 4,021,245 and 4,029,504.

Materials of the organic matting agent include starch, cellulose ester (for example, cellulose-acetate propionate), cellulose ether (for example, ethyl cellulose) and a synthetic resin. It is preferred that the synthetic resin is insoluble or difficult to become solved. Examples of synthetic resins that are insoluble or of low solubility in water include poly(meth)acrylates (for example, polyalkyl(meth)acrylate, polyalkoxyalkyl(meth)acrylate, polyglycidyl(meth)acrylate), poly(meth) acrylamide, polyvinyl ester (for example, polyvinyl acetate), polyacrylonitrile, polyolefins (for example, polyethylene), polystyrene, benzoguanamine resin, formaldehyde condensation polymer, epoxy resin, polyamide, polycarbonate, phenolic resin, polyvinyl carbazole, polyvinylidene chloride and the like.

Copolymers, that is, a combination of monomers used in the above polymers may also be used.

In the case of the copolymers, a small amount of hydrophilic repeating units may be included. Examples of monomers which constitute these hydrophilic repeating units include acrylic acid, methacrylic acid, α,β-unsaturated dicarboxylic acid, hydroxyalkyl(meth)acrylate, sulfoalkyl(meth)acrylate, styrene sulfonic acid and the like.

Examples of the organic matting agents can be found in the U.K. Patent No. 1055713, the U.S. Pat. Nos. 1,939,213, 2,221,873, 2,268,662, 2,322,037, 2,376,005, 2,391,181, 2,701,245, 2,992,101, 3,079,257, 3,262,782, 3,443,946, 3,516,832, 3,539,344, 3,591,379, 3,754,924 and 3,767,448, and JP-A Nos. 49-106821, and 57-14835.

Also, two or more types of solid particles may be used in combination. The average particle size of the solid particles may suitably be, for example, 1 μm to 100 μm, and is more preferably 4 μm to 30 μm. The usage amount of the solid particles may suitably be 0.01 g/m² to 0.5 g/m², and is more preferably 0.02 g/m² to 0.3 g/m².

The melting point (° C.) of the releasing agent is preferably 70° C. to 95° C., and more preferably 75° C. to 90° C., from the viewpoint of antioffset properties and paper transport properties.

The release agent under the present invention which is added to a toner image-receiving layer may also use derivatives, oxides, refined products, or mixtures of these. These may also have reactive substituents.

The content of the releasing agent, based on the mass of the toner image-receiving layer, is preferably 0.1% by mass to 10% by mass, more preferably 0.3% by mass to 8.0% by mass, and still more preferably 0.5% by mass to 5.0% by mass.

The content less than 0.1% by mass may make the antioffset property and adhesion resistance insufficient, while more than 10% by mass may deteriorate the image quality due to too large an amount of releasing agent.

Plasticizers

The plasticizers known in the art may be used without any particular limitation. These plasticizers have the effect of adjusting the fluidity or softening of the toner image-receiving layer due to one of heat and pressure during toner fixing.

The plasticizer may be selected by referring to Kagaku binran “Chemical Handbook” (ed. The Chemical Society of Japan, Maruzen), Kasozai—Sono riron to ouyou “Plasticizers—Theory and Application” (ed. Koichi Murai, Saiwai Shobo), Kasozai no kenkyu—jou “The Study of Plasticizers, Part 1” and Kasozai no kenkyu—ge “The Study of Plasticizers, Part 2” (ed. Polymer Chemistry Association), or Binran—Gomu purasuchikku haigou yakuhin “Handbook of Rubber and Plastics Blending Agents” (ed. Rubber Digest Co.), or the like.

Examples of the plasticizers include esters (for example, phthalic esters, phosphate esters, aliphatic acid esters, abiethyne acid ester, abietic acid ester, sebacic acid esters, azelinic ester, benzoates, butylates, epoxy aliphatic acid esters, glycolic acid esters, propionic acid esters, trimellitic acid esters, citrates, sulfonates, carboxylates, succinic acid esters, maleates, fumaric acid esters, phthalic acid esters, stearic acid esters and the like); amides (for example, aliphatic acid amides and sulfoamides and the like); ethers; alcohols; lactones; polyethyleneoxy; and the like (See JP-A Nos. 59-83154, 59-178451, 59-178453, 59-178454, 59-178455, 59-178457, 62-174754, 62-245253, 61-209444, 61-200538, 62-8145, 62-9348, 62-30247, 62-136646, and O₂-235694 and the like).

The above plasticizers can be mixed into a resin for use.

The plasticizers may be polymers having relatively low molecular weight. In this case, it is preferred that the molecular weight of the plasticizer is lower than the molecular weight of the binder resin to be plasticized. Preferably, plasticizers have a molecular weight of 15000 or less, or more preferably 5000 or less. When a polymer plasticizer is used as the plasticizer, the kind of the polymer of the polymer plasticizer is preferably the same as that of the binder resin to be plasticized. For example, when the polyester resin is plasticized, polyester having low molecular weight is preferable. Further, oligomers may also be used as plasticizers.

Apart from the compounds mentioned above, there are commercial products such as, for example, Adecasizer PN-170 and PN-1430 (from Asahi Denka Co., Ltd.); PARAPLEX-G-25, G-30 and G-40 (from C. P. Hall); and, rosin ester (ester gum) 8 L-JA, ester R-95, pentalin 4851, FK 115, 4820, 830, Ruizol 28-JA, Picolastic A75, Picotex LC and Cristalex 3085 (from Rika Hercules, Inc) and the like.

The plasticizer can be used as desired to relax stress and distortion (physical distortions such as elasticity and viscosity, and distortions of mass balance in molecules, binder main chains or pendant portions) which are produced when toner particles are embedded in the toner image-receiving layer.

The plasticizer may be dispersed in micro in the toner image-receiving layer. The plasticizer may also be dispersed in micro, in a state of sea-island, in the toner image-receiving layer. The plasticizer may present in the toner image-receiving layer in a state of sufficiently mixed with other components such as binder or the like.

The content of plasticizer in the toner image-receiving layer is preferably 0.001% by mass to 90% by mass, more preferably 0.1% by mass to 60% by mass, and still more preferably 1% by mass to 40% by mass.

The plasticizer may be used for the purpose of adjusting slidability (improvement of transportability by reducing friction), improving fixing part offset (release of toner or layer to the fixing part), adjusting curl balance, adjusting charge control (formation of a toner electrostatic image), and the like.

Colorant

The colorant is not particularly limited, and can be suitably selected according to the object. Examples of colorants include fluorescent whitening agents, white pigments, colored pigments, dyes and the like.

The fluorescent whitening agent has absorption in the near-ultraviolet region, and is a compound which emits fluorescence at 400 nm to 500 nm. Various fluorescent whitening agents known in the art may be used without any particular limitation. Examples of the fluorescent whitening agents include the compounds described in The Chemistry of Synthetic Dyes Volume V, Chapter 8 edited by K. VeenRataraman. The fluorescent whitening agent can be suitably synthesized for use, or those commercially available are usable. Specific examples of the fluorescent whitening agents include stilbene compounds, coumarin compounds, biphenyl compounds, benzo-oxazoline compounds, naphthalimide compounds, pyrazoline compounds, carbostyryl compounds and the like. Examples of the commercial fluorescent whitening agents include WHITEX PSN, PHR, HCS, PCS, and B (from Sumitomo Chemicals), UVITEX-OB (from Ciba-Geigy, Co., Ltd.), and the like.

The white pigment is not particularly limited, and can be suitably selected from those known in the art according to the object. Examples of the white pigments include the inorganic pigments such as titanium oxide, calcium carbonate and the like.

The colored pigment is not particularly limited, and can be suitably selected from those known in the art according to the object. Examples of the colored pigments include various pigments described in JP-A No. 6344653, azo pigments, polycyclic pigments, condensed polycyclic pigments, lake pigments, carbon black and the like.

Examples of the azo pigments include azo lakes (such as carmine 6B, red 2B and the like), insoluble azo compounds (such as monoazo yellow, disazo yellow, pyrazolo orange, Balkan orange and the like), condensed azo pigments (such as chromophthal yellow and chromophthal red), and the like.

Examples of the polycyclic pigments include phthalocyanines such as copper phthalocyanine blue, copper phthalocyanine green, and the like.

Examples of the condensed polycyclic pigments include dioxazines (such as dioxazine violet), isoindolinones (such as isoindolinone yellow), threne pigments, perylene pigments, perinon pigments, thioindigo pigments, and the like.

Examples of the lake pigments include malachite green, rhodamine B, rhodamine G, Victoria blue B and the like.

Examples of the inorganic pigments include oxide (titanium dioxide, iron oxide red and the like), sulfate (settling barium sulfate and the like), carbonate (settling calcium carbonate and the like), silicate (hydrous silicate, silicic anhydride and the like), metal powder (alminium powder, bronze powder, zinc powder, chrome yellow, iron blue and the like) and the like.

The above pigments can be used either alone or in combination of two or more.

The dye is not particularly limited, and can be suitably selected from those known in the art according to the object. Examples of the dyes include anthraquinone compounds, azo compounds and the like. These can be used either alone or in combination of two or more.

Examples of water-insoluble dyes include architecture dye, disperse dye, oil-soluble dye and the like.

Examples of the architecture dyes include vat dyes such as C. I. Vat violet 1, C. I. Vat violet 2, C. I. Vat violet 9, C. I. Vat violet 13, C. I. Vat violet 21, C. I. Vat blue 1, C. I. Vat blue 3, C. I. Vat blue 4, C. I. Vat blue 6, C. I. Vat blue 14, C. I. Vat blue 20, C. I. Vat blue 35 and the like. Examples of the disperse dyes include C. I. disperse violet 1, C. I. disperse violet 4, C. I. disperse violet 10, C. I. disperse blue 3, C. I. disperse blue 7, C. I. disperse blue 58 and the like. Examples of the oil-soluble dyes include C. I. solvent violet 13, C. I. solvent violet 14, C. I. solvent violet 21, C. I. solvent violet 27, C. I. solvent blue 11, C. I. solvent blue 12, C. I. solvent blue 25, C. I. solvent blue 55 and the like.

Colored couplers used in silver halide photography may also be preferably used.

A content of the colorant in the toner image-receiving layer (surface) is preferably 0.1 g/m² to 8 g/m², and more preferably 0.5 g/m² to 5 g/m².

When the content of colorant is less than 0.1 g/m², the light transmittance in the toner image-receiving layer becomes high. When it is more than 8 g/m², handling becomes more difficult, due to crack and adhesive resistance.

Among the colorants, the amount of the added pigment is, based on the mass of the thermoplastic resin constituting the toner image-receiving layer, preferably 40% by mass, more preferably 30% by mass or less, and still more preferably 20% by mass or less.

The filler may be an organic or inorganic filler. Reinforcers for binder resins, bulking agents and reinforcements known in the art may be used. The filler may be selected, referring to “Handbook of Rubber and Plastics Additives” (ed. Rubber Digest Co.), “Plastics Blending Agents—Basics and Applications” (New Edition) (Taisei Co.), “The Filler Handbook” (Taisei Co.), or the like.

As the filler, various inorganic fillers or inorganic pigments can be used suitably. Examples of inorganic fillers or inorganic pigments include silica, alumina, titanium dioxide, zinc oxide, zirconium oxide, micaceous iron oxide, white lead, lead oxide, cobalt oxide, strontium chromate, molybdenum pigments, smectite, magnesium oxide, calcium oxide, calcium carbonate, mullite and the like. Of these, silica and alumina are particularly preferred. These may be used either alone, or in combination of two or more. It is preferred that the filler has a small particle diameter. When the particle diameter is large, the surface of the toner image-receiving layer tends to become rough.

Examples of the silicas include spherical silica and amorphous silica. The silica may be synthesized by the dry method, wet method or aerogel method. The surface of the hydrophobic silica particles may also be treated by trimethylsilyl groups or silicone. Colloidal silica is preferred. The silica is preferably porous.

The alumina includes anhydrous alumina and hydrated alumina. Examples of crystallized anhydrous aluminas which may be used are α, β, γ, δ, ζ, η, θ, κ, ρ, or χ. Hydrated alumina is preferred to anhydrous alumina. The hydrated alumina may be a monohydrate or trihydrate. Monohydrates include pseudo-boehmite, boehmite and diaspore. Trihydrates include gibbsite and bayerite. Porous alumina is preferred.

The alumina hydrate can be synthesized by the sol-gel method, in which ammonia is added to an aluminum salt solution to precipitate alumina, or by hydrolysis of an alkali aluminate. Anhydrous alumina can be obtained by dehydrating alumina hydrate by the action of heat.

The amount of filler to be added is preferably from 5 parts by mass to 2000 parts by mass relative to 100 parts by mass of the dry mass of the binder of the toner image-receiving layer.

A cross-linking agent can be added in order to adjust the storage stability or thermoplastic properties of the toner image-receiving layer. Examples of the cross-linking agents include compounds containing two or more reactive groups in the molecule, such as an epoxy group, an isocyanate group, an aldehyde group, an active halogen group, an active methylene group, an acetylene group and other reactive groups known in the art.

The cross-linking agent may also be a compound having two or more groups capable of forming bonds such as hydrogen bonds, ionic bonds, coordinate bonds, or the like.

Examples of the cross-linking agents include a coupling agent for resin, curing agent, polymerizing agent, polymerization promoter, coagulant, film-forming agent, film-forming assistant, or the like. Examples of the coupling agents include chlorosilanes, vinylsilanes, epoxysilanes, aminosilanes, alkoxyaluminum chelates, titanate coupling agents and the like. The examples further include other agents known in the art such as those mentioned in Binran—Gomu purasuchikkusu no haigou yakuhin “Handbook of Rubber and Plastics Additives” (ed. Rubber Digest Co.).

The charge control agent is preferably added to adjust toner transfer, adhesion or the like to the toner image-receiving layer, and to prevent charge adhesion of the toner image-receiving layer.

The charge control agent may, without limitation, be any charge control agent known in the art. Examples of the charge control agents include surfactants such as a cationic surfactant, an anionic surfactant, an amphoteric surfactant, a nonionic surfactant, or the like; polymer electrolytes, conductive metal oxides; and the like. Examples include cationic charge inhibitors such as quaternary ammonium salts, polyamine derivatives, cation-modified polymethylmethacrylate, cation-modified polystyrene, or the like; anionic charge inhibitors such as alkyl phosphates, anionic polymers, or the like; and nonionic charge inhibitors such as aliphatic ester, polyethylene oxide, or the like. The examples are not limited thereto, however.

When the toner has a negative charge, it is preferred that the charge control agent blended with the toner image-receiving layer is, for example, cationic or nonionic.

Examples of the conductive metal oxides include ZnO, TiO₂, SnO₂, Al₂O₃, In₂O₃, SiO₂, MgO, BaO, MoO₃ and the like. These conductive metal oxides may be used alone, or may be used in combination of two or more. Moreover, the conductive metal oxide may contain (dope) other elements. For example, ZnO may contain Al, In, or the like, TiO₂ may contain Nb, Ta, or the like, and SnO₂ may contain Sb, Nb, halogen elements, or the like.

Other Additives

The materials used for the toner image-receiving layer may also contain various additives to improve image stability when output, or to improve stability of the toner image-receiving layer itself. Examples of the additives include various known antioxidants, age resistors, degradation inhibitors, ozone degradation inhibitors, ultraviolet ray absorbers, metal complexes, light stabilizers, preservatives, fungicide and the like.

The antioxidant is not particularly limited, and can be suitably selected according to the object. Examples of the antioxidants include chroman compounds, coumarane compounds, phenol compounds (for example, hindered phenols), hydroquinone derivatives, hindered amine derivatives, spiroindan compounds and the like. The antioxidants can be found in JP-A No. 61-159644.

Examples of age resistors include those found in Binran—Gomu purasuchikku haigou yakuhin—kaitei dai 2 han “Handbook of Rubber and Plastics Additives, Second Edition” (1993, Rubber Digest Co.), pp. 76-121.

The ultraviolet ray absorber is not particularly limited, and can be suitably selected according to the object. Examples of the ultraviolet ray absorbers include benzotriazol compounds (described in the U.S. Pat. No. 3,533,794), 4-thiazolidone compounds (described in the U.S. Pat. No. 3,352,681), benzophenone compounds (described in JP-A No. 46-2784), ultraviolet ray absorbing polymers (described in JP-A No. 62-260152).

The metal complex is not particularly limited, and can be suitably selected according to the object. Examples of the metal complexes include those described in U.S. Pat. Nos. 4,241,155, 4,245,018, 4254195, JP-A Nos. 61-88256, 62-174741, 63-199248, 01-75568, 01-74272 and the like.

The ultraviolet ray absorbers and light stabilizers found in Binran—Gomu purasuchikku haigou yakuhin—kaitei dai 2 han “Handbook of Rubber and Plastics Additives, Second Edition” (1993, Rubber Digest Co.), pp. 122-137 are preferably used.

Additives for photography known in the art may also be added to the material used for the toner image-receiving layer as described above. Examples of the photographic additives can be found in the Journal of Research Disclosure (hereinafter referred to as RD) No. 17643 (December 1978), No. 18716 (November 1979) and No. 307105 (November 1989). The relevant sections are shown.

TABLE 1

| Type of additive | RD17643 | RD18716 | RD307105 |
|---|---|---|---|
| 1. Whitener | p. 24 | p. 648 right | p. 868 |
| | | column | |
| 2. Stabilizer | pp. 24-25 | p. 649 right | pp. 868-870 |
| | | column | |
| 3. Light absorber | pp. 25-26 | p. 649 right | pp. 873 |
| | | column | |

(Ultraviolet ray absorber)

| | | | |
|---|---|---|---|
| 4. Colorant image | p. 25 | p. 650 right | p. 872 |
| stabilizer | | column | |
| 5. Film hardener | p. 26 | p. 651 left column | p. 874-875 |
| 6. Binder | p. 26 | p. 651 left column | p. 873-874 |
| 7. Plasticizer, lubricant | p. 27 | p. 650 right | p. 876 |
| | | column | |
| 8. Auxiliary application | pp. 26-27 | p. 650 right | pp. 875-876 |
| agent | | column | |

(Surfactant)

| | | | |
|---|---|---|---|
| 9. Antistatic agent | p. 27 | p. 650 right | p. 876-877 |
| | | column | |
| 10. Matting agent | | | pp. 878-879 |

The toner image-receiving layer under the present invention is formed by applying with a wire coater and the like the coating solution (containing thermoplastic resin for the toner image-receiving layer) to the support and by drying it. The minimum film-forming temperature (MFT) of the thermoplastic resin under the present invention is preferably the room temperature or higher, from the viewpoint of pre-print storage, and preferably 100° C. or lower, from the viewpoint of fixing toner particles.

The toner image-receiving layer under the present invention preferably has the application mass after drying in a range from 1 g/cm² to 20 g/cm², more preferably 4 g/cm² to 15 g/cm².

Thickness of the toner image-receiving layer is not particularly limited, and can be suitably selected according to the object. For example, the thickness is preferably from 1 μm to 50 μm, more preferably from 1 μm to 30 μm, still more preferably 2 μm to 20 μm, and particularly preferably 5 μm to 15 μm.

Physical Properties of Toner Image-Receiving Layer

The 180° separation strength of the toner image-receiving layer at the temperature for fixing with the fixing member is preferably 0.1 N/25 mm or less, and more preferably 0.041 N/25 mm or less. The 180° separation strength can be measured based on the method described in JIS K6887 using the surface material of the fixing member.

It is preferred that the toner image-receiving layer has a high degree of whiteness. This whiteness is measured by the method specified in JIS P 8123, and is preferably 85% or more. It is preferred that the spectral reflectance is 85% or more in the wavelength range of 440 nm to 640 nm, and that the difference between the maximum spectral reflectance and the minimum spectral reflectance in this wavelength range is within 5%. Further, it is more preferred that the spectral reflectance is 85% or more in the wavelength range from 400 nm to 700 nm, and that the difference between the maximum spectral reflectance and the minimum spectral reflectance in the wavelength is within 5%.

Specifically, for the whiteness, the value of L* is preferably 80 or more, more preferably 85 or more, and still more preferably 90 or more in a CIE 1976 (L* a* b*) color space. The color tint of the white color is preferably as neutral as possible. Regarding the color tint of the whiteness, the value of (a*)²+(b*)₂ is preferably 50 or less, more preferably 18 or less, and still more preferably 5 or less in the (L* a* b*) space.

It is preferred that the toner image-receiving layer has a high surface gloss after being formed. The 45° gloss luster is preferably 60 or more, more preferably 75 or more, and still more preferably 90 or more, over the whole range from white where there is no toner, to black where toner is densed at maximum.

However, the gloss luster is preferably 110 or less. When it is more than 110, the image has a metallic luster which is undesirable.

Gloss luster may be measured by JIS Z 8741.

It is preferred that the toner image-receiving layer has high smoothness after fixing. The arithmetic average roughness (Ra) is preferably 3 μm or less, more preferably 1 μm or less, and still more preferably 0.5 μm or less, over the whole range from white where there is no toner, to black where toner is densed at maximum.

Arithmetic average roughness may be measured by JIS B 0601, JIS B 0651, and JIS B 0652.

It is preferred that the toner image-receiving layer has one of the following physical properties, more preferred that the toner image-receiving layer has several of the following physical properties, and most preferred that the toner image-receiving layer has all of the following physical properties.
(1) Tₘ (melting temperature of toner image-receiving layer) is preferably 30° C. or more, and more preferably equal to or less than Tₘ (melting temperature of toner)+20° C.
(2) The temperature at which the viscosity of the toner image-receiving layer is 1×10⁵ cp is preferably 40° C. or higher, and more preferably lower than the corresponding temperature for the toner.
(3) At a fixing temperature of the toner image-receiving layer, the storage elasticity modulus (G′) is preferably 1×10² Pa to 1×10⁵ Pa, the loss elasticity modulus (G″) is preferably from 1×10² Pa to 1×10⁵ Pa.
(4) The loss tangent (G″/G′), which is the ratio of the loss elasticity modulus (G″) to the storage elasticity modulus (G′) at a fixing temperature of the toner image-receiving layer, is preferably from 0.01 to 10.
(5) The storage elasticity modulus (G′) at a fixing temperature of the toner image-receiving layer is preferably from −50 to +2500, relative to the storage elasticity modulus (G′) at a fixing temperature of the toner.
(6) The inclination angle on the toner image-receiving layer of the molten toner is preferably 50° or less, and more preferably 40° or less.

The toner image-receiving layer preferably satisfies the physical properties described in Japanese Patent No. 2788358, and JP-A Nos. 07-248637, 08-305067 and 10-239889.

It is preferred that the surface electrical resistance of the toner image-receiving layer is 1×10⁶ Ω/cm² to 1×10¹⁵ Ω/cm² (under conditions of 25° C., 65% RH).

When the surface electrical resistance is less than 1×10⁶ Ω/cm², the toner amount transferred to the toner image-receiving layer is insufficient, and the density of the toner image obtained may be too low. On the other hand, when the surface electrical resistance is more than 1×10¹⁵ Ω/cm², more charge than necessary is produced during transfer. Therefore, toner is transferred insufficiently, image density is low and static electricity develops, thus causing dust to adhere during handling of the electrophotographic image-receiving paper sheet. Moreover in this case, misfeed, overfeed, discharge marks, toner transfer dropout and the like may occur during the copying.

The surface electrical resistances are measured based on JIS K 6911. The sample is left with air-conditioning for 8 hours or more at a temperature of 20° C. and the humidity of 65% for humidity adjustment. Measurements are made using an R8340 produced by Advantest Ltd., under the same environmental conditions after giving an electric current for 1 minute at an applied voltage of 100 V.

Other Layers

Other layers of the toner image-receiving layer may include, for example, a surface protective layer, back layer, intermediate layer, contact improving layer, undercoat, cushion layer, charge control (inhibiting) layer, reflecting layer, tint adjusting layer, preservability improving layer, anti-adhering layer, anti-curl layer, smoothing layer and the like. These layers may have a single-layer structure or may be formed of two or more layers.

The surface protective layer is formed on the surface of the toner image-receiving layer for the purpose of protecting the surface, improving preservability, improving handling property, giving writing property, improving machine passing property, giving antioffset property and the like of the electrophotographic image-receiving paper sheet. The surface protective layer may have a single-layer structure or may be formed of two or more layers. As a binder, various kinds of thermoplastic resins, thermosetting resins and the like may be used for the surface protective layer. Resins of the binder and the toner image-receiving layer are preferably of the same kind. In this case, however, the surface protective layer and the toner image-receiving layer do not need to be the same in terms of thermodynamic property, electrostatic property and the like. Those properties can be optimized.

The surface protective layer can be blended with the various additives described above that are usable for the toner image-receiving layer. Particularly, the surface protective layer can be blended with the releasing agent used under the present invention, and other additives such as matting agent and the like. Various known matting agents are named.

The top surface layer of the electrophotographic image-receiving paper sheet (for example, the surface protective layer when formed) is preferred to have compatibility with the toner in terms of fixation property. Specifically, the top surface layer preferably has a contact angle with the melted toner in a range from 0° to 40′.

The back layer of the electrophotographic image-receiving paper sheet is preferably formed on an opposite side of the toner image-receiving layer with respect to the support, for the purpose of giving a backface output property, improving output image quality of the backface, improving curl balance, improving machine passing property and the like.

Color of the back layer is not particularly limited. In the case of both-side output type image-receiving paper sheet forming the image also on the backface, however, the color of the back layer is also preferred to be white. Like the surface, the back layer is preferred to have whiteness of 85% or more and spectral reflectance of 85% or more.

Moreover, for improving both-side output property, the back layer may have a structure same as that of the toner image-receiving layer side. The back layer may use the various kinds of additives as explained above. Examples of the blended additives include matting agent, charge control agent and the like. The back layer may have a single-layer structure or may be formed of two or more layers.

When a mold-releasing oil is used for a fixing roller and the like for preventing offset during the fixing, the back layer may have oil absorbing property.

In the electrophotographic image-receiving paper sheet, the above contact improving layer is preferred to be formed for improving the contact of the support and the toner image-receiving layer. The contact improving layer may be blended with various additives described above, particularly the cross-linking agent. Moreover, the electrophotographic image-receiving paper sheet is preferred to have a cushion layer and the like between the contact improving layer and the toner image-receiving layer, for improving receptivity of the toner.

The intermediate layer may be formed, for example, between the support and the contact improving layer, between the contact improving layer and the cushion layer, between the cushion layer and the toner image-receiving layer, between the toner image-receiving layer and the preservability improving layer and the like. In the case of the electrophotographic image-receiving paper sheet that is formed with the support, the toner image-receiving layer, and the intermediate layer, the intermediate layer can be formed, for example, between the support and the toner image-receiving layer.

<Toner>

The electrophotographic image-receiving paper sheet under the present invention is used by allowing the toner image-receiving layer to receive the toner during printing or copying.

The toner includes at least biding resin and colorant, when necessary, releasing agent and the like.

Toner's Binder Resin

The binder resin is not particularly limited, and can be selected, according to the object, from those ordinarily used for the toner. Examples of the binder resin include vinyl monopolymer of: styrenes such as styrene, parachlorostyrene, or the like; vinyl esters such as vinyl naphthalene, vinyl chloride, vinyl bromide, vinyl fluoride, vinyl acetate, vinyl propioniate, vinyl benzoate, vinyl butyrate, or the like; methylene aliphatic carboxylates such as methyl acrylate, ethyl acrylate, n-butyl acrylate, isobutyl acrylate, dodecyl acrylate, n-octyl acrylate, 2-chloroethyl acrylate, phenyl acrylate, α-methyl chloroacrylate, methyl methacrylate, ethyl methacrylate, butyl acrylate, or the like; vinyl nitriles such as acryloniotrile, methacrylonitrile, acrylamide, or the like; vinyl ethers such as vinyl methyl ether, vinyl ethyl ether, vinyl isobutyl ether, or the like; N-vinyl compounds such as N-vinyl pyrrole, N-vinylcarbazole, N-vinyl indole, N-vinyl pyrrolidone, or the like; and vinyl carboxylic acids such as methacrylic acid, acrylic acid, cinnamic acid, or the like. These vinyl monomers may be used either alone, or copolymers thereof may be used. Further, various polyesters may be used, and various waxes may be used in combination.

Among these resins, it is preferable to use a resin of the same type as the resin used for the toner image receiving layer of the present invention.

Toner's Colorant

The colorant is not particularly limited, and can be selected according to the object from those used ordinarily for the toner. Examples of the colorants include various kinds of pigments such as carbon black, chrome yellow, Hansa yellow, Benzidine Yellow, threne yellow, quinoline yellow, permanent orange GTR, pyrazolone orange, Balkan orange, watch young red, permanent red, brilliant carmine 3B, brilliant carmine 6B, dippon oil red, pyrazolone red, lithol red, rhodamine B lake, lake red C, Rose Bengale, aniline blue, ultramarine blue, chalco oil blue, methylene blue chloride, phthalocyanine blue, phthalocyanine green, malachite green oxalate and the like. Other examples include various kinds of dyes such as acridine dyes, xanthene dyes, azo dyes, benzoquinone dyes, azine dyes, anthraquinone dyes, thioindigo dyes, dioxazine dyes, thiazine dyes, azomethine dyes, indigo dyes, phthalocyanine dyes, aniline black dyes, polymethine dyes, triphenyl methane dyes, diphenyl methane dyes, thiazine dyes, thiazole dyes, xanthene dyes and the like.

The above colorants may be used alone or in combination of two or more.

A content of the colorant is not particularly limited, and can be suitably selected according to the object, preferably 2% by mass to 8% by mass. The content of the colorant less than 2% by mass may weaken tinting strength, while more than 8% by mass may lose transmittance.

Toner's Releasing Agent

The releasing agent may be in principle any of the waxes known in the art. Polar waxes containing nitrogen such as highly crystalline polyethylene wax having relatively low molecular weight, Fischertropsch wax, amide wax, urethane wax, and the like are particularly effective.

For polyethylene wax, it is particularly effective when the molecular weight is 1000 or less, and is more preferable when the molecular weight is 300 to 1000.

Since the compounds containing urethane bonds tend to stay in a solid state due to the strength of the coagulation force of the polar groups even if the molecular weight is lower, and since the melting point may be set higher in view of the molecular weight, such compounds are suitable in general. The preferred molecular weight is 300 to 1000. The raw materials may be selected from various combinations such as a diisocyanic acid compound with a mono-alcohol, a monoisocyanic acid with a mono-alcohol, dialcohol with mono-isocyanic acid, tri-alcohol with a monoisocyanic acid, and a triisocyanic acid compound with mono-alcohol. However, in order to prevent the molecular weight from becoming too large, it is preferable to combine a compound having multiple functional groups with another compound having one functional group, and it is important that the amount of functional groups be equivalent.

Examples of the monoisocyanic acid compounds include dodecyl isocyanate, phenyl isocyanate and derivatives thereof, naphthyl isocyanate, hexyl isocyanate, benzil isocyanate, butyl isocyanate, allyl isocyanate, and the like.

Examples of the diisocyanic acid compounds include tolylene diisocyanate, 4,4′ diphenylmethane diisocyanate, toluene diisocyanate, 1,3-phenylene diisocyanate, hexamethylene diisocyanate, 4-methyl-m-phenylene diisocyanate, isophorone diisocyanate, and the like.

Examples of the monoalcohols include methanol, ethanol, propanol, butanol, pentanol, hexanol, heptanol, and the like.

Examples of the dialcohols include various glycols such as ethylene glycol, diethylene glycol, triethylene glycol, trimethylene glycol, and the like.

Examples of the trialcohols include trimethylol propane, triethylol propane, trimethanol ethane, and the like.

Like an ordinary releasing agent, the above urethane compounds can be mixed with resin or colorant, to be used as mixed-pulverized type toner. When used for the toner of the emulsion polymerization melting method, the urethane compound is to be dispersed in water in combination with the ion surfactant or high molecular electrolyte (such as high molecular acid or high molecular base), and then heated to the melting point or more, then subjected to a strong shearing caused by homogenizer or pressure discharge type dispersing apparatus for forming fine-particles, to thereby prepare releasing agent particle-containing dispersing liquid (particle: 1 μm or less) which can be used in combination with the resin particle-containing dispersing liquid, the colorant-containing dispersing liquid and the like.

Other Components of Toner

The toner can be blended with other components such as inner additive, charge control agent, inorganic fine-particle, and the like. Examples of the inner additives include metals such as ferrite, magnetite, reduced iron, cobalt, nickel, manganese and the like; alloy; magnetic bodies such as compounds including the above metals; and the like.

Examples of charge control agents include those ordinarily used such as quaternary ammonium salts, nigrosine compounds, dyes made of complexes (such as aluminum, iron, chrome, and the like), triphenyl methane pigments, and the like. It is preferable that the charge control agent is unlikely to be soluble in water, from the view point of controlling ion strength which may cause an effect on stability during coagulation or meting, and the viewpoint of reducing waste water pollutant.

Examples of the inorganic fine-particles include all ordinary outer additives on the toner surface such as silica, alumina, titania, calcium carbonate, magnesium carbonate, tricalcium phosphate and the like. The above particles are preferably used by dispersing with ion surfactant, high molecular acid, and high molecular base.

Surfactants may also be used for emulsion polymerization, seed polymerization, pigment dispersion, resin particle dispersion, releasing agent dispersion, coagulation or stabilization thereof. For example, it is effective to use, in combination, anionic surfactants such as sulfuric acid ester salts, sulfonic acid salts, phosphoric acid esters, soaps, or the like; cationic surfactants such as amine salts, quaternary ammonium salts, or the like; or non-ionic surfactants such as polyethylene glycols, alkylphenol ethylene oxide adducts, polybasic alcohols, or the like. These may generally be dispersed by a rotary shear homogenizer or a ball mill, sand mill, dyno mill, or the like, all of which contain the media.

When necessary, the toner may be added by an outer additive. Examples of the outer additives include inorganic particle or organic particle. Examples of the inorganic particles include SiO₂, TiO₂, Al₂O₃, CuO, ZnO, SnO₂, Fe₂O₃, MgO, BaO, CaO, K₂O, Na₂O, ZrO₂, CaO.SiO₂, K₂O.(TiO₂)ₙ, Al₂O₃, 2SiO₂, CaCO₃, MgCO₃, BaSO₄, MgSO₄ and the like. Examples of the organic particles include fatty acids or derivatives thereof, powders of the above meal salts and the like, resin particles (such as fluorine resin, polyethylene resin, acrylic resin and the like), and the like.

Average particle diameter of the above is preferably from 0.01 μm to 5 μm, more preferably from 0.1 μm to 2 μm.

There is no particular limitation on the process of manufacturing the toner, but it is preferably manufactured by a process comprising the steps of (i) forming coagulation particles in a dispersion of resin particles to manufacture a coagulation particle dispersion, (ii) adding a fine particle dispersion to the coagulation particle dispersion so that the fine particles adhere to the coagulation particles, thus forming adhesion particles, and (iii) heating the adhesion particles which melt to form toner particles.

Physical Properties of Toner

The toner preferably has a volume average particle diameter of 0.5 μm to 10 μm. Lower than the above range may cause a harmful effect on toner's handling (supplying property, cleanability, fluidity and the like), and may decrease particle productivity. Larger than the above range may cause harmful effect on image and resolution attributable to granulariness and transferability.

It is preferable that the toner under the present invention satisfies the above range of volume average particle diameter and has a distribution index of volume average particle diameter (GSDv) of 1.3 or less.

The ratio (GSDv/GSDn) of the distribution index of volume average particle diameter (GSDv) to a distribution index of number average particle diameter (GSDn) is preferably 0.95 or more.

It is preferable that the toner under the present invention satisfies the above range of volume average particle diameter and has an average (1.00 to 1.50) of configuration indexes given by the following expression.
Configuration index=(π33 L²)/(4×S)
(where L denotes the maximum length of toner particle, and S denotes projected area of toner particle)

The toner satisfying the above conditions can bring about an effect on image, particularly granulariness and resolution. Moreover in this case, dropout or blur which may be caused by transfer is unlikely to occur, and handling may be unlikely to be influenced even when the average particle diameter becomes small.

From the viewpoint of improving image quality and preventing offset during the fixing step, it is preferable that the toner in itself has storage elasticity modulus G′ (measured at angle frequency of 10 rad/sec) of 1×10² Pa to 1×10⁵ Pa at 150° C.

<Silver Salt Photographic Material>

The silver salt photographic material has, for example, a configuration in which an image-recording layer which develops at least yellow, magenta, and cyan (YMC) is disposed on an image-recording material support under the present invention. It is generally used in, for example, silver halide photography in which an exposed and printed silver halide photographic sheet is soaked in several treatment baths one after another so as to perform color developing, bleaching and fixing, washing with water, and drying.

<Inkjet-Recording Material>

The inkjet-recording material includes, for example, a colorant-receiving layer disposed on an image-recording material support under the present invention, where the colorant-receiving layer is capable of receiving a liquid ink such as an aqueous ink (using a pigment or dye as the colorant), an oil ink and the like; a solid ink which is solid at room temperature and which is melted and liquefied when used for a print; and the like.

<Heat Transfer Material>

The heat transfer material has, for example, a configuration in which at least a heat-melting ink layer as an image-recording layer is disposed on an image-recording material support under the present invention. It is generally used in, for example, a method in which a heat sensitive head heats the heat-melting ink layer so as to melt and transfer the ink to a heat transfer sheet.

<Heat Sensitive Material>

The heat sensitive material has, for example, a configuration in which at least a heat-coloring layer is disposed on an image-recording material support under the present invention. Examples thereof include, but are not limited to, heat sensitive material and the like used in thermo-autochrome method (TA method) in which a repetition of heating by a heat sensitive head and fixing by ultraviolet light forms an image.

<Sublimation Transfer Material>

The sublimation transfer material has, for example, a configuration in which at least an ink layer containing a heat-diffusion pigment (subliming pigment) is disposed on an image-recording material support under the present invention. It is generally used in, for example, a sublimation transfer method in which a heat sensitive head heats an ink layer so as to transfer the heat-diffusion pigment to a sublimation transfer sheet.

<Printing Paper>

The image-recording material support is preferably used as printing paper. In this case, the support is preferred to have high mechanical strength since the ink is to be applied by means of a printing machine.

The raw materials used as the image-receiving material support preferably include filling material, softener, an inner additive assistant for paper, and the like. The filling materials ordinarily used are usable, whose examples including inorganic filling materials such as clay, firing clay, diatom earth, talc, kaolin, firing kaolin, delaminated kaolin, heavy calcium carbonate, soft calcium carbonate, magnesium carbonate, barium carbonate, titanium carbonate, zinc oxide, silicon oxide, amorphous silica, aluminum hydroxide, calcium hydroxide, magnesium hydroxide, zinc hydroxide and the like; organic filling materials such as urea-formalin resin, polystyrene resin, phenol resin, minor hollow particle, and the like; and the like. The above filling materials may be used alone or in combination of two or more.

Examples of the inner additive assistants for paper-making include those conventionally used such as various kinds of yield promoters which are nonionic, cationic, and anionic; freeness promoter; paper force promoter; inner additive sizing agent; and the like. Specific examples include basic aluminum compounds such as aluminum sulfate, aluminum chloride, sodium aluminate, basic aluminum chloride, basic poly(aluminum hydroxide)s; polyvalent metal compounds such as ferrous sulfate, ferric sulfate, and the like; water soluble high polymers such as starch, modified starch, polyacrylamide, urea resin, melamine resin, epoxy resin, polyamide resin, polyamine resin, polyamine, polyethylene imine, plant gum, polyvinyl alcohol, latex, polyethylene oxide, and the like; various compounds such as hydrophilic cross-linking agent polymer particle dispersion, derivatives thereof, and modified product thereof; and the like. The above materials have several functions at the same time as inner additive assistants for the paper-making.

Examples of materials having a remarkable function as inner sizing agent include alkyl ketene dimer compounds, alkenyl succinic anhydride compound, styrene-acrylic compound, higher fatty acid compound, petroleum resin sizing agent, rosin sizing agent, and the like.

Other examples of the inner sizing agents include those for paper-making such as dye, fluorescent whitening agent, pH regulator, defoaming agent, pitch control agent, slime control agent, and the like.

The printing paper is particularly preferable for offset printing paper. The other applications include relief printing, gravure printing, electrophotography, and the like.

The image-receiving material under the present invention has high-quality image and high gloss after image-forming, and causes a small curl. Therefore, the image-receiving material under the present invention is preferably used for electrophotographic material, heat sensitive material, inkjet-recording material, sublimation transfer material, silver salt photographic material, heat transfer material, and the like.

### EXAMPLES

Hereafter, the present invention will be described by means of examples, but it will be understood that the invention is not construed as being limited thereto.

### Example A-1

Preparation of Image-Recording Material Support

Broad-leaf (hardwood) tree bleached kraft pulρ (LBKP) was beaten to a Canadian Standard Freeness (C. S. F.) of 280 ml using a disk refiner, to thereby prepare a pulp paper material having fiber length of 0.60 mm.

To this pulp paper material, the following additives were added based on the pulp mass: cation starch 1.6% by mass, alkyl ketene dimer (AKD) 0.4% by mass, anion polyacrylamide 0.3% by mass, epoxidized fatty acid amide (EFA) 0.2% by mass, and polyamide polyamine epichlorohydrine 0.2% by mass. An alkyl part of the above alkyl ketene dimer originates from a fatty acid having a main component of behenic acid. A fatty acid part of the epoxidized fatty acid amide originates from a fatty acid having a main component of behenic acid.

Thereafter, the pulp paper material was treated with a manual paper-making machine to make wet paper having an absolute dry weight of 140 g/m² and water content of 68%.

Both sides of the wet paper thus obtained were covered with filter paper and dehydrated using a wet press apparatus to adjust water content to 47%.

The dehydrated wet paper was then dried with a press dry treatment apparatus similar to the one shown in FIG. 1 (Static Condebelt available from VALMET) to prepare raw paper with water content of 7.0% after drying. The press dry treatment was performed in a condition where the temperature of an upper plate which was in contact with the raw paper on the side (surface) where an image-recording layer was to be formed was set at 150° C., the temperature of a lower plate which was in contact with the raw paper on the side (backface) where no image-recording layer was to be formed was set at 85° C., pressure was set at 0.4 MPa, and drying time was set at 1 second.

The press-dry-treated raw paper was then calendered using a soft calender apparatus under the following conditions. The paper was passed through so that a metal roller having a surface temperature of 250° C. was in contact with the side (surface) of the raw paper on which an image-recording layer was to be formed, while allowing a resin roll on the opposite side to have a set surface temperature of 40° C. The thus obtained paper as the image-recording material support has a density of 0.96 g/cm³.

In this specification, including the claims, the terms “calender,” “calender apparatus,” and “calendering apparatus,” when referring to a machine used for calendering, mean the same.

### Example A-2 to Example A-4 and Comparative Example A-1 to Comparative Example A-6

Various conditions for the paper-making process were set as shown in Table 2. In the same manner as that in Example A-1, image-recording material supports of Example A-2 to Example A-4 and Comparative Example A-1 to Comparative Example A-6 were prepared.

TABLE 2

| | | | Density |
|---|---|---|---|
| | Dry | Pulp | (g/cm³) |
| Example A-1 | Press dry | LBKP = 100 | 0.87 |
| Example A-2 | Press dry | LBKP = 100 | 0.98 |
| Example A-3 | Press dry | LBKP/NBKP = 75/25 | 0.93 |
| Example A-4 | Press dry | LBKP/NBKP = 75/25 | 1.05 |
| Comparative | Press dry | LBKP/NBKP = 25/75 | 0.87 |
| Example A-1 | | | |
| Comparative | Cylinder dry | LBKP = 100 | 0.86 |
| Example A-2 | | | |
| Comparative | Cylinder dry | LBKP = 100 | 0.99 |
| Example A-3 | | | |
| Comparative | Cylinder dry | LBKP/NBKP = 75/25 | 0.97 |
| Example A-4 | | | |
| Comparative | Cylinder dry | LBKP/NBKP = 75/25 | 1.12 |
| Example A-5 | | | |
| Comparative | Cylinder dry | LBKP/NBKP = 50/50 | 0.97 |
| Example A-6 | | | |

Next, the thus obtained paper (image-recording material support) from Example A-1 to Example A-4 and Comparative Example A-1 to Comparative Example A-6 was subjected to an evaluation of inner bonding strength and planarity. The results are shown in Table 3.

<Evaluation of Inner Bonding Strength>

Inner bonding strength was measured based on JAPAN TAPPI No. 54.

<Evaluation of Planarity>

A surface configuration measuring apparatus SURFCOM 570A-3DF (made by Tokyo Seimitsu) was used for measuring the average center surface roughness (SRa) on the side (of the image-recording material support) to be formed with the image-recording layer, at the cutoff wavelength of 0.3 mm to 0.4 mm.

Measuring Condition and Analysis Condition

Scanning direction: MD direction of sample.
Measuring length: Machining paper direction (X-direction) 50 mm, and perpendicular direction (Y-direction) thereto 30 mm.
Measuring pitch: X-direction 0.1 mm, Y-direction 0.1 mm.
Scanning speed: 30 mm/sec.
Band pass filter: 0.3 mm to 0.4 mm
   [Evaluation Standards]
A: Very good (SRa is 0.8 μm or less).
B: Good (SRa is 0.8 μm to less than 0.95 μm).
C: Mediocre (SRa is 0.95 μm to less than 1.1 μm).

D: Poor (SRa is 1.1 μm or more).

TABLE 3

| | |
|---|---|
| Inner | |
| bonding | Smoothness |

| | strength | Evaluation | SRa (μm) |
|---|---|---|---|
| Example A-1 | 218 mJ | B | 0.85 |
| Example A-2 | 228 mJ | A | 0.73 |
| Example A-3 | 268 mJ | B | 0.84 |
| Example A-4 | 270 mJ | A | 0.75 |
| Comparative | 368 mJ | C | 0.97 |
| Example A-1 | | | |
| Comparative | 149 mJ | C | 0.99 |
| Example A-2 | | | |
| Comparative | 151 mJ | B | 0.91 |
| Example A-3 | | | |
| Comparative | 192 mJ | C | 1.09 |
| Example A-4 | | | |
| Comparative | 198 mJ | B | 0.93 |
| Example A-5 | | | |
| Comparative | 240 mJ | D | 1.21 |
| Example A-6 | | | |

### Example A-5 to Example A-8 and Comparative Example A-7 to Comparative Example A-12

The paper sheets (image-recording material supports) of Example A-1 to Example A-4 and Comparative Example A-1 to Comparative Example A-6 were used for preparing the electrophotographic image-receiving paper sheets, respectively, of Example A-5 to Example A-8 and Comparative Example A-7 to Comparative Example A-12, in the following methods.

Titanium Dioxide Dispersion Solution

The following components were blended and dispersed using an NBK-2 non-bubbling kneader (available from Nippon Seiki) to prepare a titanium dioxide dispersion solution (titanium dioxide pigment: 40% by mass).

| | |
|---|---|
| Titanium dioxide | 40.0 g |
| (TIPAQUE (registered Trademark) A-220, available from | |
| Ishihara Sangyo Kaisha, Ltd.) | |
| Polyvinyl alcohol | 2.0 g |
| (PVA102, available from Kuraray Co., Ltd.) | |
| Ion exchange water | 58.0 g |

Preparation of Coating Solution for Toner Image-Receiving Layer

The following components were mixed and stirred to prepare the coating solution for toner image-receiving layer.

| | | |
|---|---|---|
| Aforementioned titanium dioxide dispersion | 15.5 | g |
| solution | | |
| Carnauba wax dispersion solution | 15.0 | g |
| (Cellosol 524, available from Chukyo Yushi Co., | | |
| Ltd.) | | |
| Polyester resin aqueous dispersion | 100.0 | g |
| (solids 30% by mass, KZA-7049, Unitika Ltd.) | | |
| Thickener (Alcox E30, MEISEI CHEMICAL | 2.0 | g |
| WORKS, LTD) | | |
| Anionic surfactant (AOT) | 0.5 | g |
| Ion exchange water | 80 | ml |

The thus obtained coating solution for toner image-receiving layer had a viscosity of 40 mPa·s and a surface tension of 34 mN/m.

Preparation of Back Layer Coating Solution

The following components were mixed and stirred to prepare a back layer coating solution.

| | | |
|---|---|---|
| Acrylate resin aqueous dispersion | 100.0 | g |
| (solids 30% by mass, High-Loss XBH-997L, available from | | |
| Seiko Chemicals) | | |
| Matting agent | 5.0 | g |
| (Techpolymer MBX-12, available from Sekisui Plastics Co., | | |
| Ltd.) | | |
| Releasing agent (Hydrin D337, Chukyo Yushi Co., Ltd.) | 10.0 | g |
| Thickener (CMC) | 2.0 | g |
| Anionic surfactant (AOT) | 0.5 | g |
| Ion exchange water | 80 | ml |

The thus obtained back layer coating solution had a viscosity of 35 mPa·s and a surface tension of 33 mN/m.

Coating of Back Layer and Toner Image-Receiving Layer

To the backface (namely, the side not to be formed with the toner image-receiving layer) of the image-recording material support of each of Example A-1 to Example A4 and Comparative Example A-1 to Comparative Example A-6, the back layer coating solution was applied with a bar coater, such that the coating amount was 9 g/m² in dry mass, to thereby form the back layer. Then, to the surface of the image-recording material support, the coating solution for toner image-receiving layer was applied with a bar coater in the same manner as the back layer, such that the coating amount was 12 g/m² in dry mass, to thereby form the toner image-receiving layer. The content of the pigment in the toner image-receiving layer was 5% by mass, relative to the mass of the thermoplastic resin.

After the back layer coating solution and the toner image-receiving layer coating solution were coated, they were dried by hot air, online. Airflow and temperature for drying were adjusted, so that both the back layer and the toner image-receiving layer were dried within 2 minutes after the coating. The point of dryness was determined when the surface temperature of the coating was equal to the wet-bulb temperature of the airflow for drying.

After the drying, a calender treatment was performed. A gloss calender was used for the calender treatment in which the temperature of a metal roller was maintained at 40° C. and a nip pressure was set at 14.7 kN/m² (15 kgf/cm²).

Each of the thus obtained electrophotographic image-receiving paper sheets was cut to A4 size, and an image was printed thereon. The printer used here was a color laser printer (DocuColor 1250-PF) produced by Fuji Xerox Co., Ltd., excluding that a fixing belt apparatus 1 shown in FIG. 6 was installed.

Specifically, in the fixing belt apparatus 1 as shown in FIG. 6, a fixing belt 2 is suspended around a heating roller 3 and a tension roller 5. A cleaning roller 6 is provided via the fixing belt 2 above the tension roller 5, and a pressurizing roller 4 is further provided via the fixing belt 2 below the heating roller 3. In FIG. 6, starting from the right-hand side, the electrophotographic image-receiving paper sheet carrying a toner latent image was introduced between the heating roller 3 and the pressurizing roller 4, was fixed and then transported on the fixing belt 2. Thereafter, in this process, the electrophotographic image-receiving paper sheet was cooled by a cooling device 7, and the fixing belt 2 was finally cleaned by a cleaning roller 6.

In the fixing belt apparatus 1, the transport speed at the fixing belt 2 is 30 mm/sec, the nip pressure between the heating roller 3 and the pressurizing roller 4 was 0.2 MPa (2 kgf/cm²), and the temperature of the heating roller 3 was 150° C. which corresponded to the fixing temperature. The temperature of the pressurizing roller 4 was set at 120° C.

For each electrophotographic print thus obtained, image quality, gloss and curl were evaluated in the following manner. The results are shown in Table 4.

<Evaluation of Image Quality>

The image quality of each electrophotographic print was visually observed and was evaluated. The print with the best image quality was assigned A, followed by B, C, D and E on the following basis.

[Evaluation Standards]

A: Very good (Effective for high image quality recording material).

B: Good (Effective for high image quality recording material).

C: Mediocre (Ineffective for high image quality recording material).

D: Poor (Ineffective for high image quality recording material).

E: Very poor (Ineffective for high image quality recording material).

<Evaluation of Gloss>

The gloss of each electrophotographic print was visually observed and was evaluated. The print with the best gloss was assigned A, followed by B, C, D and E on the following basis.

[Evaluation Standards]

A: Very good (Effective for high image quality recording material).

B: Good (Effective for high image quality recording material).

C: Mediocre (Ineffective for high image quality recording material).

D: Poor (Ineffective for high image quality recording material).

E: Very poor (Ineffective for high image quality recording material).

<Evaluation of Curl>

The curl of each electrophotographic print was visually observed and was evaluated. The print with the least curl was assigned A, followed by B, C, D and E on the following basis.

[Evaluation Standards]

A: No curl is found (Effective for high image quality recording material).

B: A small curl is found, but not problematical (Effective for high image quality recording material).

C: Curl is found (Ineffective for high image quality recording material).

D: A large curl is found (Ineffective for high image quality recording material).

TABLE 4

| | | | Image | Curl |
|---|---|---|---|---|
| | Support | Gloss | quality | property |
| Example A-5 | Example A-1 | A | A | A |
| Example A-6 | Example A-2 | A | A | A |
| Example A-7 | Example A-3 | A | A | A |
| Example A-8 | Example A-4 | A | A | B |
| Comparative | Comparative | B | C | A |
| Example A-7 | Example A-1 | | | |
| Comparative | Comparative | C | C | B |
| Example A-8 | Example A-2 | | | |
| Comparative | Comparative | C | B | C |
| Example A-9 | Example A-3 | | | |
| Comparative | Comparative | C | C | B |
| Example | Example A-4 | | | |
| A-10 | | | | |
| Comparative | Comparative | C | B | C |
| Example | Example A-5 | | | |
| A-11 | | | | |
| Comparative | Comparative | C | D | A |
| Example | Example A-6 | | | |
| A-12 | | | | |

### Example A-9 to Example A-12 and Comparative Example A-13 to Comparative Example A-18

Preparation of Photographic Printing Paper

With the image-recording material supports prepared in Example A-1 to Example A-4 and Comparative Example A-1 to Comparative Example A-6, gelatin 0.1 g/m² was applied to the side (surface) to be formed with the image-recording layer. The thus obtained gelatin coat face was further coated with the overlapping coatings in the following order of: i) silver halide gelatin emulsion layer (10 g/m²) for yellow coloring photograph, ii) gelatin intermediate layer, iii) silver halide gelatin emulsion layer (10 g/m²) for magenta coloring photograph, iv) gelatin intermediate layer, v) silver halide gelatin emulsion layer (10 g/m²) for cyanogen coloring photograph, and vi) gelatin protective layer, to thereby prepare the photographic printing paper sheets, respectively, of Example A-9 to Example A-12 and Comparative Example A-13 to Comparative Example A-18.

The photographic printing papers thus obtained were exposed and developed to prepare photographic prints. For each photographic print, surface smoothness (small-scale irregularity (1 mm or less) and large-scale irregularity (5 mm to 6 mm)) was evaluated in the following manner. The results are shown in Table 5.

<Surface Smoothness (Small-Scale Irregularity (1 mm or less))>

The surface appearance of each photographic print was visually observed and was evaluated. The print with the best surface smoothness (small-scale irregularity (1 mm or less)) was assigned A, followed by B, C, D and E on the following basis.

[Evaluation Standards]

A: Very good (Effective for high image quality recording material).

B: Good (Effective for high image quality recording material).

C: Mediocre (Ineffective for high image quality recording material).

D: Poor (Ineffective for high image quality recording material).

E: Very poor (Ineffective for high image quality recording material). <Surface Smoothness (Large-Scale Irregularity (5 mm to 6 mm))>

The surface appearance of each photographic print was visually observed and was evaluated. The print with the best surface smoothness (large-scale irregularity (5 mm to 6 mm)) was assigned A, followed by B, C, D and E on the following basis.

[Evaluation Standards]

A: Very good (Effective for high image quality recording material).

B: Good (Effective for high image quality recording material).

C: Mediocre (Ineffective for high image quality recording material).

D: Poor (Ineffective for high image quality recording material).

E: Very poor (Ineffective for high image quality recording material).

TABLE 5

| | | Surface smoothness | |
|---|---|---|---|
| | | Small-scale | Large-scale |
| | | irregularity | irregularity |
| | Support | (1 mm or less) | (5 mm to 6 mm) |
| Example A-9 | Example A-1 | A | A |
| Example | Example A-2 | A | A |
| A-10 | | | |
| Example | Example A-3 | A | A |
| A-11 | | | |
| Example | Example A-4 | A | A |
| A-12 | | | |
| Comparative | Comparative | A | C |
| Example | Example A-1 | | |
| A-13 | | | |
| Comparative | Comparative | D | D |
| Example | Example A-2 | | |
| A-14 | | | |
| Comparative | Comparative | C | B |
| Example | Example A-3 | | |
| A-15 | | | |
| Comparative | Comparative | C | C |
| Example | Example A-4 | | |
| A-16 | | | |
| Comparative | Comparative | C | B |
| Example | Example A-5 | | |
| A-17 | | | |
| Comparative | Comparative | C | D |
| Example | Example A-6 | | |
| A-18 | | | |

### Example B-1

Preparation of Image-Recording Material Support

Broad-leaf (hardwood) tree bleached kraft pulρ (LBKP) was beaten to a Canadian Standard Freeness (C. S. F.) of 300 ml using a disk refiner, to thereby prepare a pulp paper material having fiber length of 0.60 mm.

To this pulp paper material, the following additives were added based on the pulp mass: cation starch 1.2% by mass, alkyl ketene dimer (AKD) 0.5% by mass, anion polyacrylamide 0.2% by mass, epoxidized fatty acid amide (EFA) 0.2% by mass, and polyamide polyamine epichlorohydrine 0.3% by mass. An alkyl part of the above alkyl ketene dimer originates from a fatty acid having a main component of behenic acid. A fatty acid part of the epoxidized fatty acid amide originates from a fatty acid having a main component of behenic acid.

Thereafter, the pulp paper material was treated with a manual paper-making machine to make wet paper having an absolute dry weight of 160 g/m² and water content of 68%.

Both sides of the wet paper were covered with filter paper and dehydrated using a wet press apparatus to adjust water content to 54%.

The dehydrated wet paper was then dried with a press dry treatment apparatus similar to the one shown in FIG. 1 (Static Condebelt available from VALMET) to prepare raw paper with water content of 7.0% after drying. The press dry treatment was performed in a condition where the temperature of an upper plate which was in contact with the raw paper on the side (surface) where an image-recording layer was to be formed was set at 150° C., the temperature of a lower plate which was in contact with the raw paper on the side (backface) where no image-recording layer was to be formed was set at 85° C., pressure was set at 0.4 MPa, and drying time was set at 1 second.

The press-dry-treated raw paper was then calendered using a soft calender apparatus under the following conditions. The paper was passed through so that a metal roller having a surface temperature of 250° C. was in contact with the side (surface) of the raw paper on which an image-recording layer was to be formed, while allowing a resin roll on the opposite side to have a set surface temperature of 40° C.

With the image-recording material support, the Oken type smoothness S (second) based on JAPAN TAPPI No. 5 method B was measured on the side (surface) to be formed with the image-recording layer. The Oken type smoothness S (second) was 251 seconds while a density ρ (g/cm³) of the image-recording material support was 0.95 g/cm³. From the above Oken type smoothness S (second) and density ρ (g/cm³), the H index (obtained by the expression S^{1/2}/ρ³) was measured to be 18.4. The results are shown in Table 6.

### Example B-2 to Example B-4 and Comparative Example B-1 to Comparative Example B-5

Various conditions for the paper-making process were set as shown in Table 6. In the same manner as that in Example B-1, image-recording material supports of Example B-2 to Example B-4 and Comparative Example B-1 to Comparative Example B-5 were prepared.

TABLE 6

| | | | ρ | | | | H |
|---|---|---|---|---|---|---|---|
| | Dry | Calender | (g/cm³) | ρ³ | S | S^{1/2} | index |
| Example B-1 | Press dry | Calendered | 0.95 | 0.86 | 251 | 15.8 | 18.4 |
| Example B-2 | Press dry | Not | 0.87 | 0.66 | 151 | 12.3 | 18.7 |
| | | calendered | | | | | |
| Example B-3 | Press dry | Calendered | 0.98 | 0.94 | 295 | 17.2 | 18.3 |
| Example B-4 | Press dry | Calendered | 1.01 | 1.03 | 315 | 17.7 | 17.2 |
| Comparative | Cylinder | Calendered | 0.81 | 0.53 | 50 | 7.07 | 13.3 |
| Example B-1 | dry | | | | | | |
| Comparative | Cylinder | Calendered | 0.89 | 0.70 | 111 | 10.5 | 14.9 |
| Example B-2 | dry | | | | | | |
| Comparative | Cylinder | Calendered | 1.05 | 1.16 | 180 | 13.4 | 11.6 |
| Example B-3 | dry | | | | | | |
| Comparative | Cylinder | Calendered | 1.12 | 1.40 | 250 | 15.8 | 11.2 |
| Example B-4 | dry | | | | | | |
| Comparative | Cylinder | Not | 0.72 | 0.37 | 17 | 4.12 | 11.0 |
| Example B-5 | dry | calendered | | | | | |

Next, the thus obtained paper (image-recording material support) from Example B-1 to Example B4 and Comparative Example B-1 to Comparative Example B-5 was subjected to an evaluation of gloss, surface planarity, and rigidity (stiffness). The results are shown in Table 7.

<Evaluation of Gloss>

The gloss of each image-recording material support was visually observed and was evaluated. The support with the best gloss was assigned A, followed by B, C, D and E on the following basis. The results are shown in Table 7.

[Evaluation Standards]

A: Very good.

B: Good.

C: Mediocre.

D: Poor.

E: Very poor.

<Evaluation of Surface Roughness>

A surface configuration measuring apparatus SURFCOM 570A-3DF (made by Tokyo Seimitsu) was used for measuring the average center surface roughness (SRa) on the side (of the image-recording material support) to be formed with the image-recording layer, at the cutoff wavelength of 5 mm to 6 mm.

Measuring Condition and Analysis Condition

Scanning direction: MD direction of sample.
Measuring length: Machining paper direction (X-direction) 50 mm, and perpendicular direction (Y-direction) thereto 30 mm.
Measuring pitch: X-direction 0.1 mm, Y-direction 0.1 mm.
Scanning speed: 30 mm/sec.
Band pass filter: 5 mm to 6 mm
   [Evaluation Standards]

A: Very good (SRa is 0.3 μm or less).

B: Good (SRa is less than 0.5 μm).

C: Mediocre (SRa is 0.5 μm to less than 1.0 em).

D: Poor (SRa is 1.0 μm to less than 2.0 μm).

E: Very poor (SRa is 2.0 μm or more).

<Evaluation of Rigidity (Stiffness)>

The rigidity (stiffness) of the image-recording material support thus obtained was evaluated by hand-touch based on standard 1 to standard 5, where the greater the figure is the better the rigidity (stiffness) is. The results are shown in Table 7.

TABLE 7

| | Surface | | Rigidity |
|---|---|---|---|
| | roughness | Gloss | (stiffness) |
| Example B-1 | A | A | 4 |
| Example B-2 | A | B | 4 |
| Example B-3 | A | A | 4 |
| Example B-4 | A | A | 3 |
| Comparative | D | D | 4 |
| Example B-1 | | | |
| Comparative | D | C | 3 |
| Example B-2 | | | |
| Comparative | B | B | 2 |
| Example B-3 | | | |
| Comparative | A | A | 1 |
| Example B-4 | | | |
| Comparative | E | D | 4 |
| Example B-5 | | | |

### Example B-5 to Example B-8 and Comparative Example B-6 to Comparative Example B-10

The paper sheets (image-recording material supports) of Example B-1 to Example B4 and Comparative Example B-1 to Comparative Example B-5 were used for preparing the electrophotographic image-receiving paper sheets, respectively, of Example B-5 to Example B-8 and Comparative Example B-6 to Comparative Example B-10, in the following methods.

Titanium Dioxide Dispersion Solution

The following components were blended and dispersed using an NBK-2 non-bubbling kneader (available from Nippon Seiki) to prepare a titanium dioxide dispersion solution (titanium dioxide pigment: 40% by mass).

| | |
|---|---|
| Titanium dioxide | 40.0 g |
| (TIPAQUE (registered Trademark) A-220, available from | |
| Ishihara Sangyo Kaisha, Ltd.) | |
| Polyvinyl alcohol | 2.0 g |
| (PVA102, available from Kuraray Co., Ltd.) | |
| Ion exchange water | 58.0 g |

Preparation of Coating Solution for Toner Image-Receiving Layer

The following components were mixed and stirred to prepare the coating solution for toner image-receiving layer.

| | | |
|---|---|---|
| Aforementioned titanium dioxide dispersion | 15.5 | g |
| solution | | |
| Carnauba wax dispersion solution | 15.0 | g |
| (Cellosol 524, available from Chukyo Yushi Co., | | |
| Ltd.) | | |
| Polyester resin aqueous dispersion | 100.0 | g |
| (solids 30% by mass, KZA-7049, Unitika Ltd.) | | |
| Thickener (Alcox E30, MEISEI CHEMICAL | 2.0 | g |
| WORKS, LTD) | | |
| Anionic surfactant (AOT) | 0.5 | g |
| Ion exchange water | 80 | ml |

The thus obtained coating solution for toner image-receiving layer had a viscosity of 40 mPa·s and a surface tension of 34 mN/m.

Preparation of Back Layer Coating Solution

The following components were mixed and stirred to prepare a back layer coating solution.

| | | |
|---|---|---|
| Acrylate resin aqueous dispersion | 100.0 | g |
| (solids 30% by mass, High-Loss XBH-997L, available from | | |
| Seiko Chemicals) | | |
| Matting agent | 5.0 | g |
| (Techpolymer MBX-12, available from Sekisui Plastics Co., | | |
| Ltd.) | | |
| Releasing agent (Hydrin D337, Chukyo Yushi Co., Ltd.) | 10.0 | g |
| Thickener (CMC) | 2.0 | g |
| Anionic surfactant (AOT) | 0.5 | g |
| Ion exchange water | 80 | ml |

The thus obtained back layer coating solution had a viscosity of 35 mPa·s and a surface tension of 33 mN/m.

Coating of Back Layer and Toner Image-Receiving Layer

To the backface (namely, the side not to be formed with the toner image-receiving layer) of the image-recording material support of each of Example B-1 to Example B-4 and Comparative Example B-1 to Comparative Example B-5, the back layer coating solution was applied with a bar coater, such that the coating amount was 9 g/m² in dry mass, to thereby form the back layer. Then, to the surface of the image-recording material support, the coating solution for toner image-receiving layer was applied with a bar coater in the same manner as the back layer, such that the coating amount was 12 g/m² in dry mass, to thereby form the toner image-receiving layer. The content of the pigment in the toner image-receiving layer was 5% by mass, relative to the mass of the thermoplastic resin.

After the back layer coating solution and the toner image-receiving layer coating solution were coated, they were dried by hot air, online. Airflow and temperature for drying were adjusted, so that both the back layer and the toner image-receiving layer were dried within 2 minutes after the coating. The point of dryness was determined when the surface temperature of the coating was equal to the wet-bulb temperature of the airflow for drying.

After the drying, a calender treatment was performed. A gloss calender was used for the calender treatment in which the temperature of a metal roller was maintained at 40° C. and a nip pressure was set at 14.7 kN/m² (15 kgf/cm²).

Each of the thus obtained electrophotographic image-receiving paper sheets was cut to A4 size, and an image was printed thereon. The printer used here was a color laser printer (DocuColor 1250-PF) produced by Fuji Xerox Co., Ltd., excluding that a fixing belt apparatus 1 shown in FIG. 6 was installed.

Specifically, in the fixing belt apparatus 1 as shown in FIG. 6, a fixing belt 2 is suspended around a heating roller 3 and a tension roller 5. A cleaning roller 6 is provided via the fixing belt 2 above the tension roller 5, and a pressurizing roller 4 is further provided via the fixing belt 2 below the heating roller 3. In FIG. 6, starting from the right-hand side, the electrophotographic image-receiving paper sheet carrying a toner latent image was introduced between the heating roller 3 and the pressurizing roller 4, was fixed and then transported on the fixing belt 2. Thereafter, in this process, the electrophotographic image-receiving paper sheet was cooled by a cooling device 7, and the fixing belt 2 was finally cleaned by a cleaning roller 6.

In the fixing belt apparatus 1, the transport speed at the fixing belt 2 is 30 mm/sec, the nip pressure between the heating roller 3 and the pressurizing roller 4 was 0.2 MPa (2 kgf/cm²), and the temperature of the heating roller 3 was 150° C. which corresponded to the fixing temperature. The temperature of the pressurizing roller 4 was set at 120° C.

For each electrophotographic print thus obtained, image quality, gloss and rigidity (stiffness) were evaluated in the following manner. The results are shown in Table 8.

<Evaluation of Image Quality>

The image quality of each electrophotographic print was visually observed and was evaluated. The print with the best image quality was assigned A, followed by B, C, D and E on the following basis.

[Evaluation Standards]

A: Very good (Effective for high image quality recording material).

B: Good (Effective for high image quality recording material).

C: Mediocre (Ineffective for high image quality recording material).

D: Poor (Ineffective for high image quality recording material).

E: Very poor (Ineffective for high image quality recording material).

<Evaluation of Gloss>

The gloss of each electrophotographic print was visually observed and was evaluated. The print with the best gloss was assigned A, followed by B, C, D and E on the following basis.

[Evaluation Standards]

A: Very good (Effective for high image quality recording material).

B: Good (Effective for high image quality recording material).

C: Mediocre (Ineffective for high image quality recording material).

D: Poor (Ineffective for high image quality recording material).

E: Very poor (Ineffective for high image quality recording material).

<Evaluation of Rigidity (Stiffness)>

The rigidity (stiffness) of each electrophotographic print thus obtained was evaluated by hand-touch based on standard 1 to standard 5, where the greater the figure is the better the rigidity (stiffness) is.

TABLE 8

| | | | Image | Rigidity |
|---|---|---|---|---|
| | Support | Gloss | quality | (stiffness) |
| Example B-5 | Example B-1 | A | A | 4 |
| Example B-6 | Example B-2 | A | B | 4 |
| Example B-7 | Example B-3 | A | A | 4 |
| Example B-8 | Example B-4 | A | A | 4 |
| Comparative | Comparative | D | D | 4 |
| Example B-6 | Example B-1 | | | |
| Comparative | Comparative | C | D | 4 |
| Example B-7 | Example B-2 | | | |
| Comparative | Comparative | C | B | 2 |
| Example B-8 | Example B-3 | | | |
| Comparative | Comparative | B | A | 2 |
| Example B-9 | Example B-4 | | | |
| Comparative | Comparative | D | E | 4 |
| Example B-10 | Example B-5 | | | |

### Example B-9 to Example B-12 and Comparative Example B-11 to Comparative Example B-15

Preparation of Photographic Printing Paper

With the image-recording material supports prepared in Example B-1 to Example B-4 and Comparative Example B-1 to Comparative Example B-5, gelatin 0.1 g/m² was applied to the side (surface) to be formed with the image-recording layer. The thus obtained gelatin coat face was further coated with the overlapping coatings in the following order of: i) silver halide gelatin emulsion layer (10 g/m²) for yellow coloring photograph, ii) gelatin intermediate layer, iii) silver halide gelatin emulsion layer (10 g/m²) for magenta coloring photograph, iv) gelatin intermediate layer, v) silver halide gelatin emulsion layer (10 g/m²) for cyanogen coloring photograph, and vi) gelatin protective layer, to thereby prepare the photographic printing paper sheets, respectively, of Example B-9 to Example B-12 and Comparative Example B-11 to Comparative Example B-15.

The photographic printing papers thus obtained were exposed and developed to prepare photographic prints. For each photographic print, surface smoothness (small-scale irregularity (1 mm or less) and large-scale irregularity (5 mm to 6 mm)) was evaluated in the following manner. The results are shown in Table 9.

<Surface Smoothness (Small-Scale Irregularity (1 mm or less))>

The surface appearance of each photographic print was visually observed and was evaluated. The print with the best surface smoothness (small-scale irregularity (1 mm or less)) was assigned A, followed by B, C, D and E on the following basis.

[Evaluation Standards]

A: Very good (Effective for high image quality recording material).

B: Good (Effective for high image quality recording material).

C: Mediocre (Ineffective for high image quality recording material).

D: Poor (Ineffective for high image quality recording material).

E: Very poor (Ineffective for high image quality recording material).

<Surface Smoothness (Large-Scale Irregularity (5 mm to 6 mm))>

The surface appearance of each photographic print was visually observed and was evaluated. The print with the best surface smoothness (large-scale irregularity (5 mm to 6 mm)) was assigned A, followed by B, C, D and E on the following basis.

[Evaluation Standards]

A: Very good (Effective for high image quality recording material).

B: Good (Effective for high image quality recording material).

C: Mediocre (Ineffective for high image quality recording material).

D: Poor (Ineffective for high image quality recording material).

E: Very poor (Ineffective for high image quality recording material).

TABLE 9

| | | Surface smoothness | |
|---|---|---|---|
| | | Small-scale | Large-scale |
| | | irregularity | irregularity |
| | Support | (1 mm or less) | (5 mm to 6 mm) |
| Example B-9 | Example B-1 | A | A |
| Example B-10 | Example B-2 | A | A |
| Example B-11 | Example B-3 | A | A |
| Example B-12 | Example B-4 | A | A |
| Comparative | Comparative | D | D |
| Example B-11 | Example B-1 | | |
| Comparative | Comparative | C | C |
| Example B-12 | Example B-2 | | |
| Comparative | Comparative | C | C |
| Example B-13 | Example B-3 | | |
| Comparative | Comparative | C | B |
| Example B-14 | Example B-4 | | |
| Comparative | Comparative | D | E |
| Example B-15 | Example B-5 | | |

Preparation of Image-Recording Material Support

Broad-leaf (hardwood) tree bleached kraft pulρ (LBKP) was beaten to a Canadian Standard Freeness (C. S. F.) of 300 ml using a disk refiner, to thereby prepare a pulp paper material having fiber length of 0.58 mm.

To this pulp paper material, the following additives were added based on the pulp mass: cation starch 1.2% by mass, alkyl ketene dimer (AKD) 0.5% by mass, anion polyacrylamide 0.3% by mass, epoxidized fatty acid amide (EFA) 0.2% by mass, and polyamide polyamine epichlorohydrine 0.3% by mass. An alkyl part of the above alkyl ketene dimer originates from a fatty acid having a main component of behenic acid. A fatty acid part of the epoxidized fatty acid amide originates from a fatty acid having a main component of behenic acid.

Thereafter, the pulp paper material was treated with a manual paper-making machine to make wet paper having an absolute dry weight of 160 g/m² and water content of 68%.

Both sides of the wet paper thus obtained were covered with filter paper and dehydrated using a wet press apparatus to adjust water content to 50%.

The dehydrated wet paper was then dried with a press dry treatment apparatus similar to the one shown in FIG. 1 (Static Condebelt available from VALMET) to prepare raw paper with water content of 7.1% after drying. The press dry treatment was performed in a condition where the temperature of an upper plate which was in contact with the raw paper on the side (surface) where an image-recording layer was to be formed was set at 160° C., the temperature of a lower plate which was in contact with the raw paper on the side (backface) where no image-recording layer was to be formed at 85° C., pressure was set at 0.45 MPa, and drying time was set at 1 second.

The press-dry-treated raw paper was then calendered using a machine calender apparatus under the following conditions. The paper was passed through so that a metal roller having a surface temperature of 110° C. was in contact with the side (surface) of the raw paper on which an image-recording layer was to be formed. The thus obtained raw paper has a density of 1.03 g/cm³.

Cast Coating Solution A

A cast coating solution A having solid density of 25% by mass was prepared which solution including 100 mass part of an amorphous silica (Fine seal X-37 made by Tokuyama) as a pigment, and 20 mass part of a polyvinyl alcohol (PVA105 made by KURARAY CO., LTD.) as a binder.

Cast Coating Solution B

A cast coating solution B having solid density of 25% by mass was prepared which solution including 100 mass part of an amorphous silica (Fine seal X-37 made by Tokuyama) as a pigment, and 10 mass part of a polyvinyl alcohol (PVA105 made by KURARAY CO., LTD.) as a binder.

Cast Coating Solution C

A cast coating solution C having solid density of 25% by mass was prepared which solution including 100 mass part of an amorphous silica (Fine seal X-37 made by Tokuyama) as a pigment, and 65 mass part of a polyvinyl alcohol (PVA105 made by KURARAY CO., LTD.) as a binder.

### Example C-1

Preparation of Image-Recording Material Support

A blade coater was used for coating a first face of a raw paper sheet with a cast coating solution A such that a dried amount of the cast coast coating solution A becomes 15 g/m². Then, a coagulant (borax/water/surfactant (made by Dainippon Ink and Chemicals Inc.)=97.8/2/0.2) was applied for performing coagulation such that its solid mass becomes 0.5 g/m². Then, while being in a wet state, the thus obtained coat surface is pressed to a cast drum having a surface temperature of 100° C., to thereby produce an image-recording material support of Example C-1.

### Example C-2

Preparation of Image-Recording Material Support

Example C-1 was repeated, except that the cast coating solution A was replaced with a cast coating solution B, to thereby produce an image-recording material support of Example C-2.

### Example C-3

Preparation of Image-Recording Material Support

Example C-1 was repeated, except that the cast coating solution A was replaced with a cast coating solution C, to thereby produce an image-recording material support of Example C-3.

### Comparative Example C-1

Preparation of Image-Recording Material Support

Example C-1 was repeated, except that the cast coat treatment using the cast coating solution A was not performed, to thereby produce an image-recording material support of Comparative Example C-1.

### Comparative Example C-2

Preparation of Image-Recording Material Support

Example C-1 was repeated, except that the raw paper used was not subjected to the press dry treatment, to thereby produce an image-recording material support of Comparative Example C-2.

Then, the supports of Example C-1 to Example C-3 and Comparative Example C-1 to Comparative Example C-2 were evaluated in terms of gloss and surface roughness. The results are shown in Table 10.

<Evaluation of Gloss>

The gloss of each support was visually observed and was evaluated. The support with the best gloss was assigned A, followed by B, C, D and E on the following basis.

[Evaluation Standards]

A: Very good.

B: Good.

C: Mediocre.

D: Poor.

E: Very poor.

<Evaluation of Surface Smoothness>

A surface configuration measuring apparatus SURFCOM 570A-3DF (made by Tokyo Seimitsu) was used for measuring the average center surface roughness (SRa) on the side (of the image-recording material support) to be formed with the image-recording layer, at the cutoff wavelength of 5 mm to 6 mm.

Measuring Condition and Analysis Condition

Scanning direction: MD direction of sample.
Measuring length: Machining paper direction (X-direction) 50 mm, and perpendicular direction (Y-direction) thereto 30 mm.
Measuring pitch: X-direction 0.1 mm, Y-direction 0.1 mm.
Scanning speed: 30 mm/sec.
Band pass filter: 5 mm to 6 mm
   [Evaluation Standards]

A: Very good (SRa is 0.3 μm or less).

B: Good (SRa is less than 0.5 μm).

C: Mediocre (SRa is 0.5 μm to less than 1.0 μm).

D: Poor (SRa is 1.0 μm to less than 2.0 μm).

E: Very poor (SRa is 2.0 μm or more).

TABLE 10

| | | Surface |
|---|---|---|
| | Gloss | smoothness |
| Example C-1 | A | A |
| Example C-2 | A | B |
| Example C-3 | B | A |
| Comparative | D | D |
| Example C-1 | | |
| Comparative | C | D |
| Example C-2 | | |

### Example C-4 to Example C-6 and Comparative Example C-3 to Comparative Example C-4

The paper sheets (image-recording material supports) of Example C-1 to Example C-3 and Comparative Example C-1 to Comparative Example C-2 were used for preparing the electrophotographic image-receiving paper sheets, respectively, of Example CA1 to Example C-6 and Comparative Example C-3 to Comparative Example C-4, in the following methods.

Titanium Dioxide Dispersion Solution

The following components were blended and dispersed using an NBK-2 non-bubbling kneader (available from Nippon Seiki) to prepare a titanium dioxide dispersion solution (titanium dioxide pigment: 40% by mass).

| | |
|---|---|
| Titanium dioxide | 40.0 g |
| (TIPAQUE (registered Trademark) A-220, available from | |
| Ishihara Sangyo Kaisha, Ltd.) | |
| Polyvinyl alcohol | 2.0 g |
| (PVA102, available from Kuraray Co., Ltd.) | |
| Ion exchange water | 58.0 g |

Preparation of Coating Solution for Toner Image-Receiving Layer

The following components were mixed and stirred to prepare the coating solution for toner image-receiving layer.

| | | |
|---|---|---|
| Aforementioned titanium dioxide dispersion | 15.5 | g |
| solution | | |
| Carnauba wax dispersion solution | 15.0 | g |
| (Cellosol 524, available from Chukyo Yushi Co., | | |
| Ltd.) | | |
| Polyester resin aqueous dispersion | 100.0 | g |
| (solids 30% by mass, KZA-7049, Unitika Ltd.) | | |
| Thickener (Alcox E30, MEISEI CHEMICAL | 2.0 | g |
| WORKS, LTD) | | |
| Anionic surfactant (AOT) | 0.5 | g |
| Ion exchange water | 80 | ml |

The thus obtained coating solution for toner image-receiving layer had a viscosity of 40 mPa s and a surface tension of 34 mN/m.

Preparation of Back Layer Coating Solution

The following components were mixed and stirred to prepare a back layer coating solution.

| | | |
|---|---|---|
| Acrylate resin aqueous dispersion | 100.0 | g |
| (solids 30% by mass, High-Loss XBH-997L, available from | | |
| Seiko Chemicals) | | |
| Matting agent | 5.0 | g |
| (Techpolymer MBX-12, available from Sekisui Plastics Co., | | |
| Ltd.) | | |
| Releasing agent (Hydrin D337, Chukyo Yushi Co., Ltd.) | 10.0 | g |
| Thickener (CMC) | 2.0 | g |
| Anionic surfactant (AOT) | 0.5 | g |
| Ion exchange water | 80 | ml |

The thus obtained back layer coating solution had a viscosity of 35 mPa·s and a surface tension of 33 mN/m.

Coating of Back Layer And Toner Image-Receiving Layer

To the backface (namely, the side not to be formed with the toner image-receiving layer) of the image-recording material support of each of Example C-1 to Example C-3 and Comparative Example C-1 to Comparative Example C-2, the back layer coating solution was applied with a bar coater, such that the coating amount was 9 g/m² in dry mass, to thereby form the back layer.

Then, to the surface of the image-recording material support, the coating solution for toner image-receiving layer was applied with a bar coater in the same manner as the back layer, such that the coating amount was 12 g/m² in dry mass, to thereby form the toner image-receiving layer. The content of the pigment in the toner image-receiving layer was 5% by mass, relative to the mass of the thermoplastic resin.

After the back layer coating solution and the toner image-receiving layer coating solution were coated, they were dried by hot air, online. Airflow and temperature for drying were adjusted, so that both the back layer and the toner image-receiving layer were dried within 2 minutes after the coating. The point of dryness was determined when the surface temperature of the coating was equal to the wet-bulb temperature of the airflow for drying.

After the drying, a calender treatment was performed. A gloss calender was used for the calender treatment in which the temperature of a metal roller was maintained at 40° C. and a nip pressure was set at 14.7 kN/m² (15 kgf/cm²).

Each of the thus obtained electrophotographic image-receiving paper sheets was cut to A4 size, and an image was printed thereon. The printer used here was a color laser printer (DocuColor 1250-PF) produced by Fuji Xerox Co., Ltd., excluding that the fixing belt apparatus 1 shown in FIG. 6 was installed.

Specifically, in the fixing belt apparatus 1 as shown in FIG. 6, a fixing belt 2 is suspended around a heating roller 3 and a tension roller 5. A cleaning roller 6 is provided via the fixing belt 2 above the tension roller 5, and a pressurizing roller 4 is further provided via the fixing belt 2 below the heating roller 3. In FIG. 6, starting from the right-hand side, the electrophotographic image-receiving paper sheet carrying a toner latent image was introduced between the heating roller 3 and the pressurizing roller 4, was fixed and then transported on the fixing belt 2. Thereafter, in this process, the electrophotographic image-receiving paper sheet was cooled by a cooling device 7, and the fixing belt 2 was finally cleaned by a cleaning roller 6.

In the fixing belt apparatus 1, the transport speed at the fixing belt 2 is 30 mm/sec, the nip pressure between the heating roller 3 and the pressurizing roller 4 was 0.2 MPa (2 kgf/cm²), and the temperature of the heating roller 3 was 150° C. which corresponded to the fixing temperature. The temperature of the pressurizing roller 4 was set at 120° C.

For each electrophotographic print thus obtained, image quality and gloss were evaluated in the following manner. The results are shown in Table 11.

<Evaluation of Image Quality>

The image quality of each electrophotographic print was visually observed and was evaluated. The print with the best image quality was assigned A, followed by B, C, D and E on the following basis.

[Evaluation Standards]

A: Very good (Effective for high image quality recording material).

B: Good (Effective for high image quality recording material).

C: Mediocre (Ineffective for high image quality recording material).

D: Poor (Ineffective for high image quality recording material).

E: Very poor (Ineffective for high image quality recording material).

<Evaluation of Gloss>

The gloss of each electrophotographic print was visually observed and was evaluated. The print with the best gloss was assigned A, followed by B, C, D and E on the following basis.

[Evaluation Standards]

A: Very good (Effective for high image quality recording material).

B: Good (Effective for high image quality recording material).

C: Mediocre (Ineffective for high image quality recording material).

D: Poor (Ineffective for high image quality recording material).

E: Very poor (Ineffective for high image quality recording material).

TABLE 11

| | | | Image |
|---|---|---|---|
| | Support | Gloss | quality |
| Example C-4 | Example C-1 | A | A |
| Example C-5 | Example C-2 | A | B |
| Example C-6 | Example C-3 | B | A |
| Comparative | Comparative | D | D |
| Example C-3 | Example C-1 | | |
| Comparative | Comparative | C | D |
| Example C-4 | Example C-2 | | |

### Example C-7 to Example C-9 and Comparative Example C-5 to Comparative Example C-6

Preparation of Photographic Printing Paper

With the image-recording material supports prepared in Example C-1 to Example C-3 and Comparative Example C-1 to Comparative Example C-2, gelatin 0.1 g/m² was applied to the side (surface) to be formed with the image-recording layer. The thus obtained gelatin coat face was further coated with the overlapping coatings in the following order of: i) silver halide gelatin emulsion layer (10 g/m²) for yellow coloring photograph, ii) gelatin intermediate layer, iii) silver halide gelatin emulsion layer (10 g/m²) for magenta coloring photograph, iv) gelatin intermediate layer, v) silver halide gelatin emulsion layer (10 g/m²) for cyanogen coloring photograph, and vi) gelatin protective layer, to thereby prepare the photographic printing paper sheets, respectively, of Example C-7 to Example C-9 and Comparative Example C-5 to Comparative Example C-6.

The photographic printing papers thus obtained were exposed and developed to prepare photographic prints. For each photographic print, surface smoothness (small-scale irregularity (1 mm or less) and large-scale irregularity (5 mm to 6 mm)) was evaluated in the following manner. The results are shown in Table 12.

<Surface Smoothness (Small-Scale Irregularity (1 mm or less))>

The surface appearance of each photographic print was visually observed and was evaluated. The print with the best surface smoothness (small-scale irregularity (1 mm or less)) was assigned A, followed by B, C, D and E on the following basis.

[Evaluation Standards]

A: Very good (Effective for high image quality recording material).

B: Good (Effective for high image quality recording material).

C: Mediocre (Ineffective for high image quality recording material).

D: Poor (Ineffective for high image quality recording material).

E: Very poor (Ineffective for high image quality recording material).

<Surface Smoothness (Large-Scale Irregularity (5 mm to 6 mm))>

The surface appearance of each photographic print was visually observed and was evaluated. The print with the best surface smoothness (large-scale irregularity (5 mm to 6 mm)) was assigned A, followed by B, C, D and E on the following basis.

[Evaluation Standards]

A: Very good (Effective for high image quality recording material).

B: Good (Effective for high image quality recording material).

C: Mediocre (Ineffective for high image quality recording material).

D: Poor (Ineffective for high image quality recording material).

E: Very poor (Ineffective for high image quality recording material).

TABLE 12

| | | Surface smoothness | |
|---|---|---|---|
| | | Small-scale | Large-scale |
| | | irregularity | irregularity |
| | Support | (1 mm or less) | (5 mm to 6 mm) |
| Example C-7 | Example C-1 | A | A |
| Example C-8 | Example C-2 | A | B |
| Example C-9 | Example C-3 | A | A |
| Comparative | Comparative | D | C |
| Example C-5 | Example C-1 | | |
| Comparative | Comparative | C | D |
| Example C-6 | Example C-2 | | |

Under the present invention, an image-recording material support can be provided which has high planarity and excellent gloss. Moreover under the present invention, an image-recording material can be provided which allows an image-recording face after image-recording to have high-quality image and high gloss, and cause a small curl.

1. A paper comprising:
a raw paper,
wherein the paper satisfies at least one of the following conditions (i) and (ii):
(i) the paper has an inner bonding strength of 160 mJ or more specified in Japan Technical Association of the Pulp and Paper Industry No. 54, and an average center surface roughness on at least one face of the paper is 0.9 μm or less at a cutoff wavelength of 0.3 mm to 0.4 mm, and
(ii) an Oken type smoothness S (second) on the at least one face of the paper, and a density ρ (g/cm³) of the paper satisfy an expression S^{1/2}/ρ³≧15.

2. The paper according to claim 1, wherein the paper has the inner bonding strength of 200 mJ or more.

3. The paper according to claim 1, wherein the paper satisfies an expression S^{1/2}/ρ³≧17.

4. The paper according to claim 1, wherein the Oken type smoothness S (second) of the paper is 100 seconds or more.

5. The paper according to claim 1, wherein the density ρ of the paper is 0.85 g/cm³ to 1.05 g/cm³.

6. The paper according to claim 1, wherein the raw paper comprises a broad-leaf tree pulp.

7. The paper according to claim 6, wherein a content of the broad-leaf tree pulp is 50% by mass or more.

8. The paper according to claim 1, wherein the paper is subjected to at least one of a press dry treatment and a calender treatment.

9. The paper according to claim 8, wherein an Oken type smoothness Si (second) on a face of the paper that is subjected to the press dry treatment, and a density ρ₁ (g/cm³) of the paper after the press dry treatment satisfy an expression S^{1/2}/ρ₁³≧15.

10. The paper according to claim 8, wherein a heating temperature at the press dry treatment is 100° C. to 200° C.

11. The paper according to claim 8, wherein a pressure at the press dry treatment is 0.05 MPa to 1.5 MPa.

12. The paper according to claim 8, wherein the press dry treatment comprises:
drying at a temperature from 100° C. to 200° C. a wet paper having a water content of 30% to 70% while applying a pressure to a face on a side of the wet paper on which side an image-recording layer is to be formed.

13. An image-recording material support, comprising:
a paper which comprises a raw paper,
wherein the paper satisfies at least one of the following conditions (i) and (ii):
(i) the paper has an inner bonding strength of 160 mJ or more specified in Japan Technical Association of the Pulp and Paper Industry No. 54, and an average center surface roughness on at least one face of the paper is 0.9 μm or less at a cutoff wavelength of 0.3 mm to 0.4 mm, and
(ii) an Oken type smoothness S (second) on the at least one face of the paper, and a density ρ (g/cm³) of the paper satisfy an expression S^{1/2}/ρ³≧15.

14. The image-recording material support according to claim 13, wherein the paper is subjected to at least one of a press dry treatment and a calender treatment.

15. An image-recording material support, comprising:
a raw paper subjected to a press dry treatment; and
a coat layer,
wherein the coat layer is made by subjecting a face of the raw paper to a surface treatment using a member with a smooth surface, the face of the raw paper being to be formed with an image-recording layer.

16. The image-recording material support according to claim 15, wherein the smooth surface of the member is a mirror face of a surface of a metal drum.

17. The image-recording material support according to claim 15, wherein the coat layer is a cast coat layer.

18. The image-recording material support according to claim 15, wherein the face subjected to the press dry treatment has an average center surface roughness of 0.5 μm or less at a cutoff wavelength of 5 mm to 6 mm.

19. An image-recording material, comprising:
an image-recording material support comprising a paper which comprises a raw paper; and
an image-recording layer disposed on the image-recording material support,
wherein the paper satisfies at least one of the following conditions (i) and (ii):
(i) the paper has an inner bonding strength of 160 mJ or more specified in Japan Technical Association of the Pulp and Paper Industry No. 54, and an average center surface roughness on at least one face of the paper is 0.9 μm or less at a cutoff wavelength of 0.3 mm to 0.4 mm, and
(ii) an Oken type smoothness S (second) on the at least one face of the paper, and a density ρ (g/cm³) of the paper satisfy an expression S^{1/2}/ρ³≧15.

20. The image-recording material according to claim 19, wherein the image-recording material is selected from the group consisting of an electrophotographic material, a heat sensitive material, an inkjet-recording material, a sublimation transfer material, a silver salt photographic material, and a heat transfer material.

21. An image-recording material, comprising:
an image-recording material support, comprising;
a raw paper subjected to a press dry treatment, and
a coat layer; and
an image-recording layer disposed on the image-recording material support,
wherein the coat layer is made by subjecting a face of the raw paper to a surface treatment using a member with a smooth surface, the face of the raw paper being to be formed with an image-recording layer.

22. The image-recording material according to claim 21, wherein the coat layer is a cast coat layer.

23. The image-recording material according to claim 21, wherein the image-recording material is selected from the group consisting of an electrophotographic material, a heat sensitive material, an inkjet-recording material, a sublimation transfer material, a silver salt photographic material, and a heat transfer material.
